(19) United States
(12) Patent Application Publication
(10) Pub. No.: US 2010/0002021 A1
(43) Pub. Date: Jan. 7, 2010

(54) Display panel driving method and display apparatus

(75) Inventors: Yoshiharu Hashimoto, Kanagawa (JP); Keigo Ootani, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/457,991

(22) Filed: Jun. 26, 2009

(30) Foreign Application Priority Data
Jun. 30, 2008 (JP) 2008-170543
Jun. 18, 2009 (JP) 2009-145561

(51) Int. Cl. G09G 5/10; G09G 3/36

(52) U.S. Cl. 345/690; 345/88

(57) ABSTRACT

A method of driving a display panel is provided. The display panel includes a first scan group including first to third scan lines, and a plurality of data lines which intersect the first to third scan lines, and first display cells of a first color which are connected with the first scan line, second display cells of a second color which are connected with the second scan line, third display cells of a third color which are connected with the third scan line. The method is achieved by precharging the data lines to a predetermined voltage in a first horizontal period; and by supplying a data signal to the first to third display cells through the data lines driving of the first to third display cells after the data lines are precharged in the first horizontal period. In the driving of the first to third display cells, one of the first to third display cells corresponding to one of said first to third colors, having a maximum spectral luminous efficacy, is first driven.

### INCORPORATION BY REFERENCE

This patent application claims priorities on convention based on Japanese Patent Application Nos. 2008-170543 and 2009-145561. The disclosures thereof are incorporated herein by reference.

### BACKGROUND OF THE INVENTION

1. Field of the Invention

The present invention relates to a method for driving a display panel, and a display apparatus, and more specifically, to a technique of driving a display panel in which a color array of display cells is in a horizontal stripe pattern.

2. Description of Related Art

A liquid crystal display panel of a matrix type in which liquid crystal cells are arranged in a matrix is one of the most typical display apparatuses. The liquid crystal display panel is provided with the liquid crystal cells, scan lines, each of which selects a row of the liquid crystal cells, and data lines through which the data signal is supplied. The liquid crystal cells are arranged at intersection positions of the scan lines and the data lines. The liquid crystal cell includes a TFT (Thin Film Transistor) and a pixel electrode, and a liquid crystal is filled between the pixel electrode and a common electrode facing it.

In order to control degradation of a liquid crystal material upon driving the liquid crystal display panel, a polarity of the data signal supplied to the pixel electrode is inverted every predetermined period. The inversion system includes frame inversion drive, column inversion drive, line inversion drive, dot inversion drive, etc. Among these, the dot inversion driving method is of driving data lines so that voltage polarities of adjacent pixels differ from one another, and is known by its excellent image quality. Generally, in the dot inversion drive, all the data lines are short-circuited to neutralize charges stored in the data lines before the polarity of the data signal is inverted, in order to reduce a current consumption amount of the data signal. This has a same effect as precharging, and since all the data lines become almost near a voltage of a common electrode, the pixels are not affected by a signal level of the data signal outputted immediately before the short-circuit.

Generally, one pixel of the liquid crystal display panel includes three liquid crystal cells, i.e. a liquid crystal cell for displaying red (R), a liquid crystal cell for displaying green (G), and a liquid crystal cell for displaying blue (B). Most typically, the liquid crystal cell that displays a same color is connected to the same data line. In this case, color filters provided for the liquid crystal display panel become in a vertical stripe pattern. In case of the liquid crystal display panel corresponding to WXGA (Wide eXtended Graphic Arrangement: 1280×768 pixels), if the color filter is of a vertical stripe type, the number of data lines is 3840 and the number of scan lines is 768.

In a liquid crystal display apparatus in recent years, color filters for red (R), green (G), and blue (B) may be arranged in a horizontal stripe pattern (for example, see Japanese Patent Application Publication (JP-A-Heisei 9-80466: related art 1)). In this case, the liquid crystal cells for displaying the same color are connected to the same scan line. An advantage of arranging the color filters of the horizontal stripe type is in that the number of data lines becomes ⅓ and the number of data driver ICs can be reduced. Reduction of the number of data driver ICs is desirable for reduction of the cost. For example, since the number of data lines is 1280 in the liquid crystal display panel corresponding to the WXGA, what is necessary is just to mount one data driver IC of 1280 outputs.

However, when the horizontal stripe arrangement is adopted, the number of scan lines increases threefold and one scan period becomes short to about ⅓ times that of the vertical stripe arrangement. Therefore, many problems occur. One problem is color reproducibility. When the horizontal stripe arrangement is adopted, the column inversion drive is adopted in many cases since one scan period is short. Here, in the column inversion drive, the polarities of the data signals are different between adjacent data lines, and the polarity of the data signal is inverted every frame period. However, the column inversion drive is susceptible to an influence of a preceding data signal, and the color reproducibility is degraded. For example, when a green raster pattern is intended to be displayed, the liquid crystal cells of red (R) and blue (B) are supplied with a data signal V0 to make the transmittance of light minimum, and the liquid crystal cell of green (G) is supplied with a data signal V63 to make the transmittance of light maximum. If the color arrangement is an order of red (R), green (G), and blue (B) from the top, the liquid crystal cell of red (R) is not affected by the preceding data signal since the liquid crystal cell of red (R) is supplied with the data signal with a same voltage level as that of the liquid crystal cell of blue (B) of a preceding data signal. However, a voltage actually applied to the liquid crystal cell of green (G) is affected by the data signal (the voltage V0) supplied to the liquid crystal cell of red (R), e.g. becomes about a voltage V61 of making the cell darker by two gray scale levels. On the other hand, a voltage actually applied to the liquid crystal cell of blue (B) is affected by the data signal V63 of the liquid crystal cell of green (G), e.g. becomes about a voltage V2 of making the cell brighter by two gray scale levels. Therefore, an original color is not reproducible. Although this phenomenon has been described assuming that the degree of the influence is as much as two gray scale levels as one example, the voltage actually applied to the liquid crystal cell may be shifted from an original voltage by three gray scale levels or more. A voltage shift amount becomes large at a position far from the data driver IC to have a round waveform of a data signal.

### SUMMARY

In an aspect of the present invention, a method of driving a display panel is provided. The display panel includes a first scan group of first to third scan lines arranged continuously in this order, and data lines which intersect the first to third scan lines, and first display cells of a first color which are connected with the first scan line, second display cells of a second color which are connected with the second scan line, third display cells of a third color which are connected with the third scan line. The method is achieved by precharging the data lines to a predetermined voltage in a first horizontal period; and by supplying a data signal to the first to third display cells through the data lines to drive the first to third display cells after the data lines are precharged in the first horizontal period. In the driving of the first to third display cells, one of the first to third display cells corresponding to one of the first to third colors, having a maximum spectral luminous efficacy, is first driven.

In another aspect of the present invention, a display apparatus includes a data driver; a display panel; and a scan line driver circuit. The display panel includes a first scan group of first to third scan lines arranged continuously in this order; data lines which intersect the first to third scan lines, first display cells of a first color which are connected with the first scan line; second display cells of a second color which are connected with the second scan line; and third display cells of a third color which are connected with the third scan line. The data driver precharges the data lines to a predetermined voltage in a first horizontal period, and supplies a data signal to the first to third display cells through the data lines to drive the first to third display cells, after the data lines are precharged in the first horizontal period. The scan line driver circuit first drives one of the first to third scan lines corresponding to one of said first to third colors having a maximum spectral luminous efficacy.

According to the present invention, color reproducibility of a display panel of a horizontal stripe arrangement can be improved.

### BRIEF DESCRIPTION OF THE DRAWINGS

The above and other objects, advantages and features of the present invention will be more apparent from the following description of certain exemplary embodiments taken in conjunction with the accompanying drawings, in which:

FIG. 1 is a block diagram showing a configuration of a liquid crystal display apparatus in a first embodiment of the present invention;

FIG. 2 is a circuit diagram showing a configuration of a data driver IC in the first embodiment of the present invention;

FIG. 3 is a conceptual diagram showing a method of driving a liquid crystal display panel in the first embodiment;

FIG. 4 shows timing charts of the method of driving the liquid crystal display panel in the first embodiment;

FIG. 5 is a table showing a relation of a drive order of liquid crystal cells, influence of a preceding data signal, and power consumption amount;

FIG. 6 shows graphs of a gamma curve applied to the liquid crystal cell of green and a gamma curve applied to the liquid crystal cells of red and blue;

FIG. 7 is a conceptual diagram showing the method of driving the liquid crystal display in a second embodiment of the present invention;

FIG. 8 shows timing charts in the method of driving the liquid crystal display panel in a third embodiment of the present invention;

FIG. 9 shows timing charts in the method of driving the liquid crystal display panel in the third embodiment;

FIG. 10A is a conceptual diagram showing a configuration of the liquid crystal display panel in a fourth embodiment of the present invention;

FIG. 10B is a plan view showing the configuration of the liquid crystal display panel according to the fourth embodiment of the present invention;

FIG. 11 is a conceptual diagram showing the method of driving the liquid crystal display panel according to a fifth embodiment of the present invention;

FIG. 12 is a conceptual diagram showing the method of driving the liquid crystal display panel according to the fifth embodiment of the present invention;

FIG. 13 is a conceptual diagram showing the method of driving the liquid crystal display panel according to the fifth embodiment of the present invention;

FIG. 14 is a table showing a scan order of scan lines in the liquid crystal display panel according to the fifth embodiment of the present invention;

FIG. 15 is a conceptual diagram showing the method of driving the liquid crystal display panel according to a sixth embodiment of the present invention;

FIG. 16 is a table showing the scan order of scan lines in the liquid crystal display panel according to the sixth embodiment of the present invention;

FIG. 17 shows timing charts of the liquid crystal display panel according to the sixth embodiment of the present invention;

FIG. 18 is a table showing the scan order of scan lines in the liquid crystal display panel according to a seventh embodiment of the present invention; and

FIG. 19 shows timing charts of the liquid crystal display panel according to the seventh embodiment of the present invention.

### DESCRIPTION OF PREFERRED EMBODIMENTS

Hereinafter, a liquid crystal display apparatus according to the present invention will be described in detail with reference to the attached drawings.

### First Embodiment

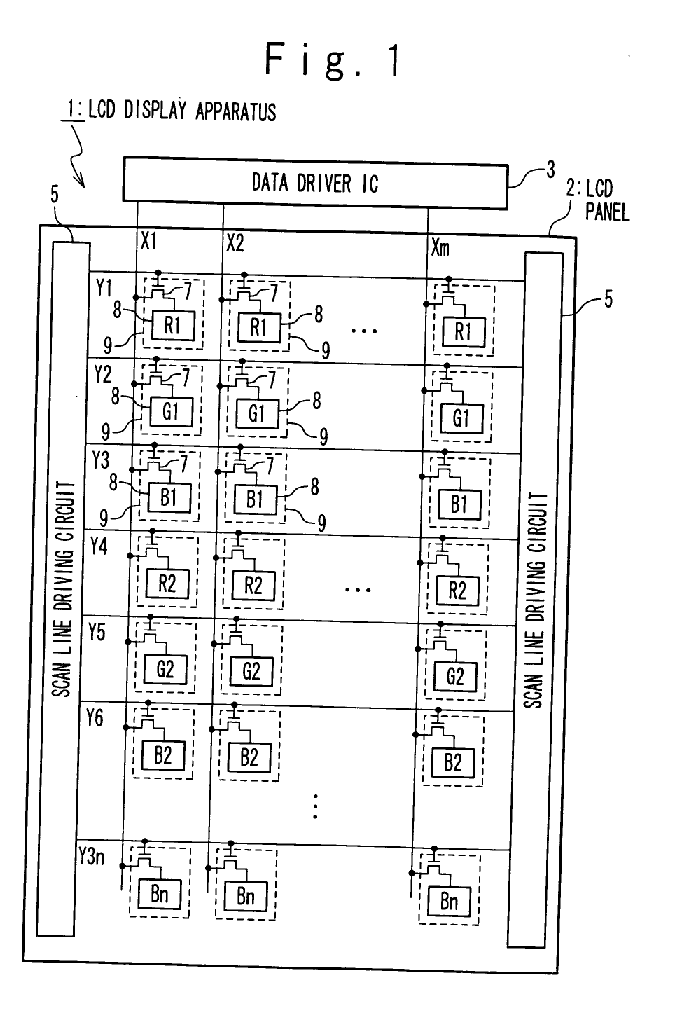

FIG. 1 is a block diagram showing a configuration of a liquid crystal display apparatus according to a first embodiment of the present invention. The liquid crystal display apparatus 1 has a liquid crystal display panel 2 and a data driver IC 3 with a timing control circuit built therein. The data driver IC 3 drives data lines X1 to Xm of the liquid crystal display panel 2. Also, the data driver IC 3 supplies a control signal to a scan line driving circuit 5 and supplies a fixed voltage to a common electrode. As mounting states of the data driver IC 3, there are COG (Chip On Glass), COF (Chip On Film), TCP (Tape Carrier Package), etc.

In the liquid crystal display panel 2, the data lines X1 to Xm and scan lines Y1 to Y3n are formed, and liquid crystal cells 9 are formed at intersections of these lines to function as a display cell. The liquid crystal cell 9 is provided with a TFT 7 (Thin Film Transistor) of functioning as a switching element and a pixel electrode 8. A liquid crystal is filled between the pixel electrode 8 and a common electrode facing it in each liquid crystal cell 9. Gate electrodes of the TFTs 7 are connected to the scan lines Y1 to Y3n, source electrodes of the TFTs 7 are connected to the data lines X1 to Xm, and drain electrodes of the TFTs 7 are connected to the pixel electrodes 8, respectively. The scan line driving circuit 5 is formed on the liquid crystal display panel 2 to supply scan signals to the scan lines Y1 to Y3n. In order to reduce waveform rounding of the scan signal, it is desirable that scan line driving circuits 5 are provided on right and left sides of the liquid crystal display panel 2, and drive one scan line from two right and left sides simultaneously.

In the liquid crystal cell 9, an auxiliary capacitance is often provided between a pixel electrode 8 and a scan line scanned immediately previously. Depending on the structure of a liquid crystal cell 9, it is not always necessary to provide the auxiliary capacitance. However, depending on the scan order, the pixel electrode 8 receives influence of coupling noise from the scan line Y or the pixel electrode in another row so that the image quality is degraded. Therefore, an auxiliary capacitance line 6 (not shown) is desirably provided between the pixel electrode 8 and the scan line to have a capacitance function and a shield function. The same voltage as that applied to the common electrode is applied to the auxiliary capacitance line 6 and a shield electrode.

Color filters of a horizontal stripe pattern type are provided to cover the liquid crystal cell 9. The liquid crystal cells 9 connected to the same scan line are covered with the color filter of the same color. In detail, a color filter of red (R) is provided for the liquid crystal cells 9 connected to a scan line Y(3i−2), a color filter of green (G) is provided for the liquid crystal cells 9 connected to a scan line Y(3i−1), and a color filter of blue (B) is provided for the liquid crystal cells 9 connected to a scan line Y3i. In the following description, the liquid crystal cell 9 for which the color filter of red (R) is provided is called an R liquid crystal cell, the liquid crystal cell 9 for which the color filter of green (G) is provided is called a G liquid crystal cell, and the liquid crystal cell 9 for which the color filter of blue (B) is provided is called a B liquid crystal cell. One pixel includes the R liquid crystal cell, the G liquid crystal cell, and the B liquid crystal cell, which constitute a matrix of three rows by one column. In FIG. 1, the R liquid crystal cell connected to the scan line Y(3i−2) is designated by a symbol “Ri,” the G liquid crystal cell connected to the scan line Y(3i−1) is designated by a symbol “Gi,” and the B liquid crystal cell connected to the scan line Y3i is designated by a symbol “Bi.” The scan line connected to the R liquid crystal cell is called an R scan line, the scan line connected to the G liquid crystal cell is called a G scan line, and the scan line connected to the B liquid crystal cell is called a B scan line.

In the liquid crystal display panel having the number of pixels corresponding to WXGA (1280×768 pixels), when the color filters are in a vertical stripe pattern, the data lines are 3840 and the scan lines are 768. On the other hand, like the present embodiment, when the color filters are in the horizontal stripe pattern, the data lines are 1280 and the scan lines are 2304. Therefore, only a data driver IC 3 with 1280 outputs is mounted on the liquid crystal display panel 2.

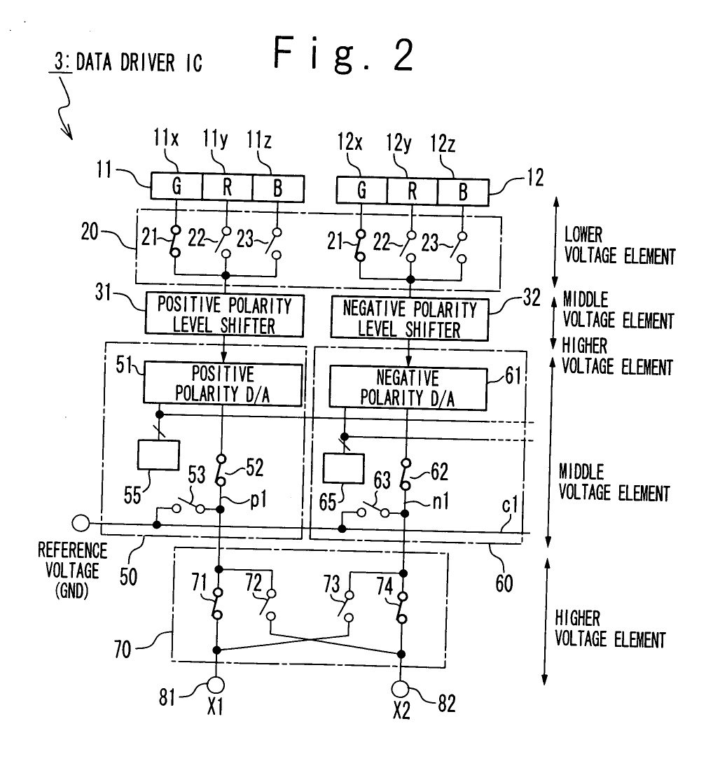

FIG. 2 is a circuit diagram showing a configuration of the data driver IC 3. FIG. 2 shows a circuit portion for driving the two data lines X1 and X2 in the data driver IC 3. The person skilled in the art could understand that a circuit portion for driving other data lines is configured similarly. The data driver IC 3 has latch circuits 11 and 12, a multiplexer 20, a positive polarity level shifter 31, a negative polarity level shifter 32, a positive electrode driving circuit 50, a negative electrode driving circuit 60, a polarity switching circuit 70, and output terminals 81 and 82. In addition, although being not shown, the data driver IC 3 also includes input terminals of the image data, a clock signal and so on, a shift register circuit, a timing control circuit, a data buffer, etc. The data driver IC of a line sequential drive has a 2-stage configuration of a sampling latch and a hold latch. The latch circuits 11 and 12 are hold latches. It should be noted that the sampling latch is not illustrated. A data buffer supplies the image data to the sampling latch and the image data is sequentially latched by the sampling latch in response to a sampling signal outputted from the shift register circuit. The latched image data is transferred to latch circuits 11 and 12 at the start of one horizontal period in response to a latch signal STB.

The latch circuits 11 and 12 hold the image data for one horizontal period. The latch circuit 11 is provided with a latch 11x for latching the image data of green (G), a latch 11y for latching the image data of red (R), and a latch 11z for latching the image data of blue (B). Here, the image data of green (G) is a data for specifying a gray scale level of the G liquid crystal cell, the image data of red (R) is a data for specifying a gray scale level of the R liquid crystal cell, and the image data of blue (B) is a data for specifying a gray scale level of the B liquid crystal cell. Similarly, the latch circuit 12 is provided with a latch 12x for latching the image data of green (G), a latch 12y for latching the image data of red (R), and a latch 12z for latching the image data of blue (B).

The multiplexer 20 is provided with a plurality of switches 21, 22, and 23. In detail, the switches 21, 22, and 23 are provided between the latches 11x, 11y, and 11z and the positive polarity level shifter 31, respectively. Similarly, the switches 21, 22, and 23 are provided between the latches 12x, 12y, and 12z and the negative polarity level shifter 32, respectively. The latch circuits 11 and 12 and the multiplexer 20 are formed with lower voltage elements, and operate in a voltage between GND (0 V) and VCC (3 V).

The positive polarity level shifter 31 is formed from middle voltage elements (namely, an element having a middle breakdown voltage), and performs a level shifting operation of an input voltage in a range from 0 V to 3 V to a range from 0 V to 6 V. The negative polarity level shifter 32 is formed from the middle voltage elements and higher voltage elements (namely, an element having a high withstand voltage), and performs a level shifting operation of the input voltage in a range from 0 V to 3 V to a range from −5 V to 0 V.

The positive electrode driving circuit 50 outputs the data signal of positive polarity according to the image data, and is provided with a positive polarity D/A conversion circuit 51, switches 52 and 53, and a positive polarity gray scale voltage generating circuit 55. The switch 52 is provided between the positive polarity D/A conversion circuit 51 and a node p1. The switch 53 is provided between the node p1 and a reference voltage line c1. The positive electrode driving circuit 50 is formed from the middle voltage elements, and operates in a voltage range from GND (0 V) to VPH (6 V).

The negative electrode driving circuit 60 outputs the data signal of negative polarity according to the image data, and is provided with a negative polarity D/A conversion circuit 61, switches 62 and 63, and a negative polarity gray scale voltage generating circuit 65. The switch 62 is provided between the negative polarity D/A conversion circuit 61 and a node n1, the switch 63 is provided between the node n1 and the reference voltage line c1. The negative electrode driving circuit 60 is formed from the middle voltage elements, and operates in a voltage range from VNL (−5 V) to GND (0 V).

Each of the number of the positive polarity D/A conversion circuits 51 and that of the negative polarity D/A conversion circuits 61 is a half of the number of the data lines X1 to Xm, and when the liquid crystal display panel 2 supports WXGA, it is 640 for each. It should be noted that existence of one positive polarity gray scale voltage generating circuit 55 and one negative polarity gray scale voltage generating circuit 65 is sufficient in the data driver IC 3. The positive electrode driving circuit 50 and the negative electrode driving circuit 60 are electrically separated by a deep well, SOI (Silicon on Insulator), or the like.

The positive polarity gray scale voltage generating circuit 55 divides voltages by series-connected resistances to generate gray scale voltages of the positive polarity. The positive polarity gray scale voltage generating circuit 55 is provided with a circuit for generating a lowest brightness voltage V0p, a circuit for generating a highest brightness voltage V63p, and a circuit for fine tuning. The positive polarity gray scale voltage generating circuit 55 is provided with a register for G for specifying a shape of the gamma curve when the G liquid crystal cell is driven by the data signal of positive polarity and a register for RB for specifying the shapes of the gamma curves when the R liquid crystal cell and the B liquid crystal cell are driven by the data signals of positive polarity. Thereby, the positive polarity gray scale voltage generating circuit 55 can independently control the gamma curve when the G liquid crystal cell is driven by the data signal of positive polarity and the gamma curves when the R liquid crystal cell and the B liquid crystal cell are driven by the data signals of positive polarity.

Similarly, the negative polarity gray scale voltage generating circuit 65 divides voltages by the series-connected resistances to generate the gray scale voltage of the negative polarity. The negative polarity gray scale voltage generating circuit 65 is provided with a circuit for generating a minimum brightness voltage V0n, a circuit for generating a maximum brightness voltage V63n, and a circuit for fine tuning. The negative polarity gray scale voltage generating circuit 65 is provided with a register for G for specifying the shape of a gamma curve when the G liquid crystal cell is driven by the data signal of the negative polarity and the register for RB for specifying the shape of a gamma curve when the R liquid crystal cell and the B liquid crystal cell are driven by the data lines of the negative polarity. Thereby, the negative polarity gray scale voltage generating circuit 65 can independently control the gamma curve when the G liquid crystal cell is driven by the data signal of negative polarity and the gamma curve when the R liquid crystal cell and the B liquid crystal cell are driven by the data signals of the negative polarity.

The polarity switching circuit 70 is provided with a plurality of switches 71, 72, 73, and 74. The switch 71 is provided between the node p1 and the output terminal 81, and the switch 72 is provided between the node p1 and the output terminal 82. The switch 73 is provided between the node n1 and the output terminal 81, and the switch 74 is provided between the node n1 and the output terminal 82. The polarity switching circuit 70 is formed from the higher voltage elements and operates in a voltage range from VNL (−5 V) to VPH (6 V). The polarity switching circuit 70 may operate in a scan non-selection voltage Vgoff and a scan selection voltage Vgon. The polarity switching circuit 70 may be formed on the liquid crystal display panel 2 in the same manner as the scan line driving circuit 5.

For simplicity of a diagram, a control signal for controlling each switch is not illustrated in FIG. 2. The switch 52 and the switch 62 are controlled at almost the same timing according to separate control signals with different voltage levels. The switch 53 and the switch 63 are also controlled at almost the same timing according to separate control signals with different voltage levels. The switch 71 and the switch 74 are controlled by a same control signal. The switch 72 and the switch 73 are also controlled by a same control signal. It is desirable that the control signals for these switches are supplied in a direction from the right and left ends of the data driver IC 3 to a central part thereof. This is because it is necessary to provide an extended interconnection on the liquid crystal display panel 2. If the extended interconnections at the left and right ends are long, the resistances becomes larger, since a distance between output terminals of the data driver IC 3 is narrower than a distance between the data lines. For this reason, the waveform dullness of the data signal at the left and right ends becomes large compared with that of the data signal at the center so that an effective write time at the left and right ends becomes short. For this reason, in order to equalize a write voltage to the liquid crystal cells regardless of a position on the liquid crystal display panel 2, the write time of the data signal at the center is made shorter than that of the data signal at the left and right ends. However, when a scan line is driven at the same time from the left and right ends, the write time at the center becomes short since the waveform dullness of the scan signal is large at the center of the liquid crystal display panel 2 while the waveform dullness of the scan signal is small at the left and right ends. Therefore, it is desirable that the output timing of the data signal can be appropriately adjusted such that a write voltage difference due to the waveform dullness of the scan signal and the waveform dullness of the data signal is cancelled. The advantages can be obtained that EMI can be reduced as well as image quality can be made uniform, when the output timing of the data signal is different.

A timing control circuit generates control signals necessary for timing control of the data driver IC 3 and the scan line driving circuit 5 in response to a clock signal CLK, a horizontal synchronization signal HS, and a vertical synchronization signal VS, all of which are supplied from an external circuit. Since an operating voltage is different between the data driver IC 3 and the scan line driving circuit 5, the control signals are supplied to respective circuit portions of the data driver IC 3 and the scan line driving circuit 5 through the level shifters. The timing control circuit is provided with a counter for counting the horizontal synchronization signal HS, and it is desirable that as the distance from the data driver IC 3 to the scan line to which the liquid crystal cell 9 is connected becomes farther, the voltage amplitude (a difference between a minimum brightness voltage V0 and a maximum brightness voltage V63) of a gamma curve of green (G) thereof is made larger. In other words, a correction value is made large for the liquid crystal cell 9 which is far from the data driver IC 3 and which receives a signal with a large waveform dullness and the correction value is made small for the liquid crystal cell 9 which is near to the data driver IC 3 and which receives the signal with a small waveform dullness. The counter is reset with the vertical synchronization signal VS. In the gray scale voltage generating circuits 55 and 65, gray scale voltages depending on a setting value of a register for G and a value held in the counter are generated.

It should be noted that, in the above data driver IC 3, data signals of opposite polarity are supplied to an odd-numbered data line X(2k−1) and an even-numbered data line X2k, respectively. For example, when the data signal of the positive polarity is outputted from the odd-numbered data line X(2k−1), the data signal of the negative polarity is outputted from an even-numbered data line X2k. On the contrary, when the data signal of the negative polarity is outputted from the odd-numbered data line X(2k−1), the data signal of the positive polarity is outputted from the even-numbered data line X2k.

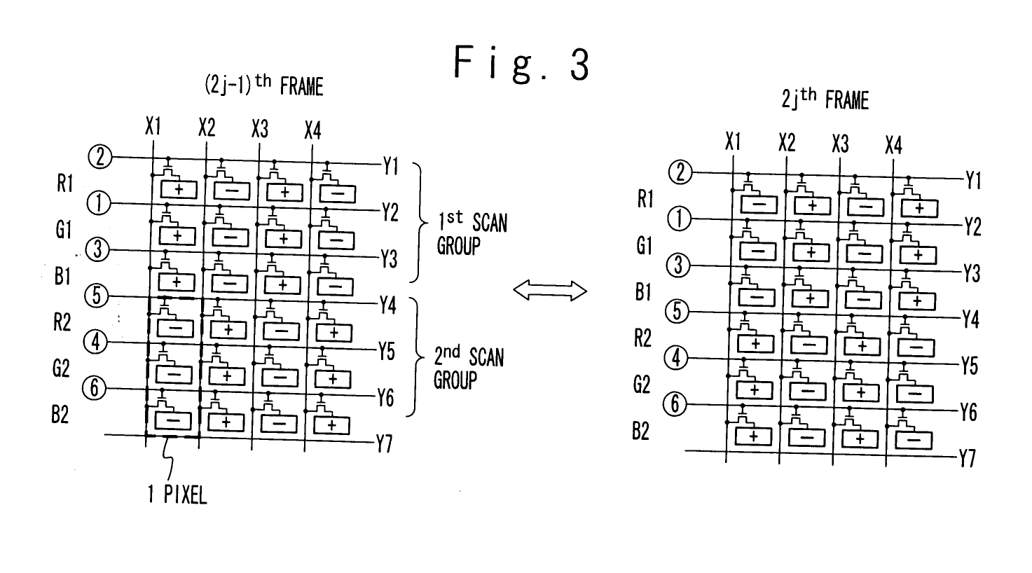

Subsequently, a method of driving the liquid crystal display panel 2 in the present embodiment will be described with reference to FIG. 3. In FIG. 3, in order to simplify the explanation, a method of driving the liquid crystal cells 9 connected to six scan lines Y1 to Y6 and four data lines X1 to X4. Circled numbers in FIG. 3 show a sequence in which the scan lines Y1 to Y6 are scanned, and symbols “+” and “−” in FIG. 3 indicate the polarities of the data signals supplied to the liquid crystal cells 9, respectively. A symbol “+” indicates that a data signal of the positive polarity is supplied, and a symbol “−” indicates that a data signal of the negative polarity is supplied. Since the target liquid crystal cells 9 are arranged to form six rows by four columns and each pixel is formed from the liquid crystal cells 9 of three rows by one column, FIG. 3 showing pixels of two rows by four columns.

In the present embodiment, three scan lines being continuously located constitute one scan group. One among the three scan lines of the one scan group is a scan line connected to the R liquid crystal cell, one of the remaining scan lines is a scan line connected to the G liquid crystal cell, and the last scan line is a scan line connected to the B liquid crystal cell. In the following description, the scan lines Y1, Y2, and Y3 are called a first scan group, and the scan lines Y4, Y5, and Y6 are called a second scan group. Similarly, scan lines Y(3i−2), Y(3i−1), and Y3i are called an i^{th} scan group (i is a natural number). If the liquid crystal display panel 2 has the number of pixels corresponding to WXGA, i is an integer between 1 and 768. In the present embodiment, the scan line is selected in an order of the first scan group, the second scan group . . . , and the n^{th} scan group.

In the present embodiment, three scan periods are defined in one horizontal period (a time period in which the horizontal synchronization signal HS is activated). Here, the scan period is a period in which one scan line is selected, and the liquid crystal cells 9 connected to the selected scan line are driven. Since the three scan lines are included in the one scan group, the scan lines of the one scan group are selected in the one horizontal period. In case of the liquid crystal display panel 2 whose color filters are in a horizontal stripe arrangement, the one scan period becomes short compared with the case of a vertical stripe arrangement. That is, when the color arrangement is of a vertical stripe, one scan period is defined for one horizontal period, whereas when the color arrangement is of a horizontal stripe, three scan periods are defined in one horizontal period. In the driving of the liquid crystal display panel 2 that adopts the horizontal stripe arrangement, the one scan period becomes shorter to about ⅓ of the scan period of the vertical stripe arrangement. Therefore, it brings many demerits, especially the demerit of degradation in color reproducibility.

In the driving method of the present embodiment, in order to improve the color reproducibility, the G liquid crystal cells connected to the G scan line are driven immediately after all the data lines X1 to Xm were precharged to a predetermined reference voltage (typically, a system ground voltage GND). Precharging is performed by short-circuiting all the data lines X1 to Xm to a reference voltage line cl of the system ground voltage.

In detail, immediately after the precharging, the G scan line is selected, and therewith the data signal according to the image data of green (G) is supplied to each of the data lines X1 to Xm. The reason why the G liquid crystal cell is driven immediately after the precharging is to eliminate an influence of the data signal supplied immediately before, from the voltage used to actually drive the G liquid crystal cells. Green color has a high spectral luminous efficacy compared with red color and blue color, and a brightness difference is easily recognizable. Therefore, when the data signal is supplied to the G liquid crystal cell, the color reproducibility degrades if due to the influence of the data signal supplied immediately before, the voltage actually applied to the G liquid crystal cell shifts from a desired voltage level. By driving the G liquid crystal cells immediately after the precharging, it is possible to eliminate the influence of the data signal supplied immediately before, from the voltage used to actually drive the G liquid crystal cell.

Subsequently, after the driving of the G liquid crystal cell, the R liquid crystal cells connected to the R scan line and the B liquid crystal cells connected to the B scan line are driven. In the operation of FIG. 3, first, the R scan line is selected, and the data signals according to the image data of red (R) are supplied to the respective data lines X1 to Xm. Thus, the R liquid crystal cells are driven. Further, the B scan line is selected, and the data signals according to the image data of blue (B) are supplied to the respective data lines X1 to Xm. Thus, the B liquid crystal cells are driven. The driving of the R liquid crystal cells and the B liquid crystal cells is affected by the data signals supplied immediately before it. For example, the voltage used to actually drive the R liquid crystal cell is affected by the data signal supplied for the driving of the G liquid crystal cell immediately before. The voltage used to actually drive the B liquid crystal cell is affected by the data signal supplied for the driving of the R liquid crystal cell immediately before. However, since the red color and the blue color have low spectral luminous efficacies compared with green color, even if there is the influence of the data signal supplied immediately before, the influence upon actually observed color is small.

In this way, in the driving method of FIG. 3, by driving the G liquid crystal cell immediately after the precharging, the influence of the data signal immediately before is eliminated from the voltage used to actually drive the G liquid crystal cell, and thereby the color reproducibility is improved. It should be noted that although the B liquid crystal cell is driven after the driving of the R liquid crystal cell in the driving method of FIG. 3, a sequence of driving of the R liquid crystal cell and the B liquid crystal cell may be inverted.

In order to improve the quality of image still more, the polarity of the data signal is inverted between the adjacent data lines, and inverted every horizontal period (namely, every three scan periods) in the present embodiment. Such a driving method may be called 3G inversion drive in subsequent description. A common electrode is kept at a fixed common voltage in the 3G inversion drive of the present embodiment. With reference to FIG. 3, the polarity of the data signal in a (2j−1)^{th} frame period will be described below as a specific example. Regarding the liquid crystal cells 9 connected to the scan lines Y1 to Y3, the polarities of the data signals supplied to the liquid crystal cells 9 connected to the data lines X1 and X3 are positive, whereas the polarities of the data signals supplied to the liquid crystal cells 9 connected to the data lines X2 and X4 are negative. On the other hand, regarding the liquid crystal cells 9 connected to the scan lines Y4 to Y6, the polarities of the data signals supplied to the liquid crystal cells 9 connected to the data lines X1 and X3 are negative, whereas the polarities of the data signals supplied to the liquid crystal cells 9 connected to the data lines X2 and X4 are positive. The polarities of voltages applied to all the liquid crystal cells 9 are inverted during the 2j frame period. By adoption of such 3G inversion drive, it is possible to suppress flicker in the vertical stripe pattern and cross talk in a window pattern that are problems in the column inversion drive.

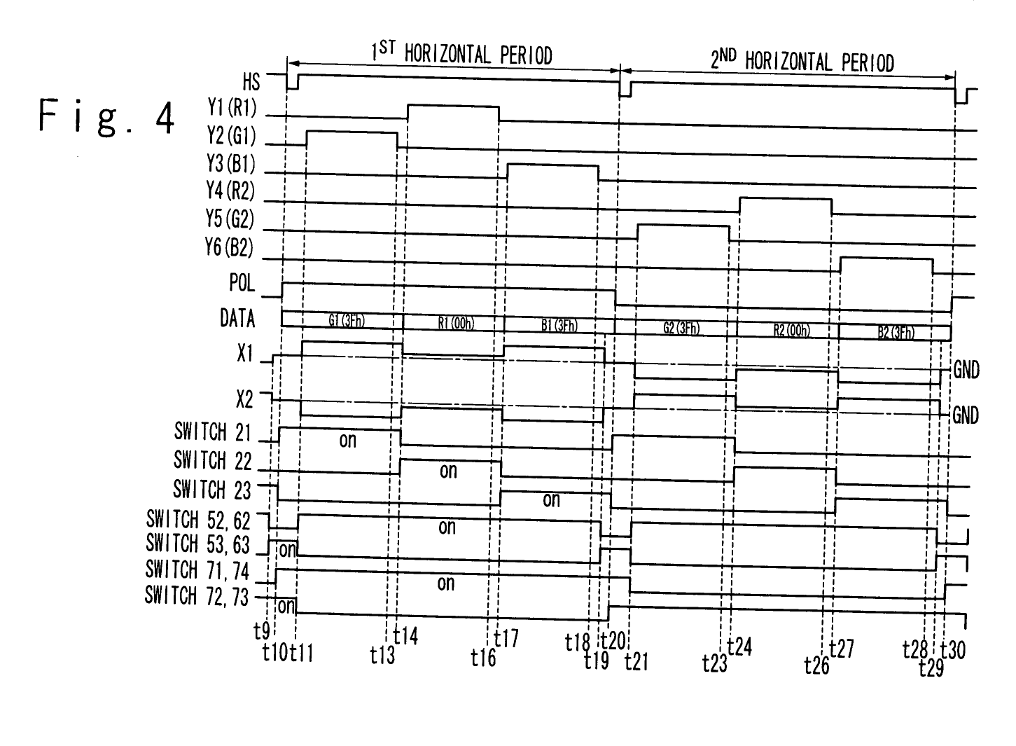

Next, the method of driving the liquid crystal display panel 2 in the present embodiment will be described below in detail with reference to timing charts of FIG. 4. It is assumed that the image data is 6 bits (64 gray scale levels), and a liquid crystal of the liquid crystal cell 9 is normally black. Furthermore, the binary number 000000 equivalent to the zero gray scale level is expressed by 00h in a hexadecimal notation, and the binary number 111111 equivalent to the 63^{rd} gray scale level is expressed by 3Fh in the hexadecimal notation. When a value of the image data is 00h, the transmittance of light becomes a minimum (black), and when it is 3Fh, the transmittance of light becomes a maximum (white). A gray scale voltage of the positive polarity when the image data is 00h is described as V0p, and a gray scale voltage of the negative polarity for the same image data is described as V0n. Furthermore, a gray scale voltage of the positive polarity when the image data is 3Fh is described as V63p, and a gray scale voltage of the negative polarity for the same image data is described as V63n. The timing charts of FIG. 4 show a display example of a cyan raster pattern as a display pattern that a power consumption amount due to the data signal becomes a maximum. In order to display a cyan raster pattern, the image data of red (R) is set to 00h, the image data of green (G) is set to 3Fh, and the image data of blue (B) is set to 3Fh over the whole plane of the liquid crystal display panel 2. Below, although only operations related to the driving of the liquid crystal cell 9 connected to the data lines X1, X2 are referred to, the person skilled in the art can easily understand that the liquid crystal cell 9 connected to other data line is also similarly driven.

In FIG. 4, the time t10 is a start time of a first horizontal period of a (2j−1)^{th} frame period. The states of the switches immediately before the time t9 that is prior to the time t10 are as follows. The switches 21 and 22 hold a turn-off state, and the switch 23 holds a turn-on state. The switches 53 and 63 have been turned on, and the switches 52 and 62 have been turned off. The switches 71 and 74 hold a turn-off state and the switches 72 and 73 hold a turn-on state. In this state, outputs of the D/A conversion circuits 51 and 61 are high impedance (hereinafter, it is abbreviated to Hi-Z). In the following description, only when the on/off state of each switch changes, the switch will be referred to.

At the time t9 immediately before the first horizontal period is started, the precharging of the data lines X1 and X2 to GND is started. In detail, the switches 53 and 63 are turned on, and the switches 52 and 62 are turned off. When the switches 53 and 63 are turned on, the precharging of the data lines X1 and X2 to GND is started.

Subsequently, at the time t10, the first horizontal period is started. First, at the time t10, the switches 71 and 74 are turned on. When the switches 71 and 74 are turned on, four switches of the switches 71 to 74 are all in the turn-on state, so that driving capability is improved. Thus, the precharging of the data lines X1 and X2 to GND is accelerated.

Furthermore, at the time t10, the switch 21 is turned on, the switch 23 is turned off, and the image data are transferred to the latch circuits 11 and 12 from a logic circuit (not shown). In logic sections in preceding stages of the latch circuits 11 and 12, the image data are processed to be transferred to the latch circuit 12 corresponding to the target data lines. The gray scale voltage generating circuits 55 and 65 are set to generate the gray scale voltages corresponding to the gamma curve of green (G). When the switch 21 is turned on, the image data of green (G) is inputted into the positive polarity level shifter 31, and the gray scale voltage of the positive polarity according to the image data is selected in the positive polarity D/A conversion circuit 51. The image data of green (G) is supplied to the negative polarity level shifter 32, and the gray scale voltage of the negative polarity according to the image data is selected in the negative polarity D/A conversion circuit 61.

Next, at a time t11, the switches 52 and 62 are turned on, the switches 53 and 63 are turned off, and the switches 72, 73 are turned off. At the same time, the scan line Y2 of the first scan group is selected, and is pulled up to a voltage Vgon. It should be noted that the scan line Y2 is the scan line connected to the G liquid crystal cells. In this state, the data signal V63p of the positive polarity of green (G) is supplied to the data line X1, the data signal V63n of the negative polarity of green (G) is supplied to the data line X2, and the TFT 7 connected to the selected scan line Y2 is turned on. Thereby, the data signal of green (G) is supplied to a pixel electrode 8 of each of the G liquid crystal cells connected to the scan line Y2. The scan line Y2 may be selected between the time t10 and the time t11, namely in the middle of the precharging.

Next, at a time t13, the scan line Y2 is set to a non-selected state, and the voltage of the signal is pulled down to the voltage Vgoff. Thereby, the TFT 7 of each of the G liquid crystal cells connected to the scan line Y2 is turned off, and the data signal of green (G) is held at the pixel electrode 8 of the G liquid crystal cell.

Next, at a time t14, the switch 21 is turned off, the switch 22 is turned on, and the image data of red (R) is supplied to the level shifters 31 and 32. In the D/A conversion circuits 51 and 61, gray scale voltages according to the image data are selected. At the same time, the scan line Y1 of the first scan group is selected. It should be noted that the scan line Y1 is a scan line connected to the R liquid crystal cells. The gray scale voltage generating circuits 55 and 65 generate the gray scale voltages corresponding to the gamma curves of red (R) and blue (B). In this state, the data signal V0p of the positive polarity of red (R) is supplied to the data line X1, the data signal V0n of the negative polarity of red (R) is supplied to the data line X2, and the TFT 7 connected to the selected scan line Y1 is turned on. Thus, the data signal of red (R) is supplied to a pixel electrode 8 of each of the R liquid crystal cells connected to the scan line Y1.

Next, at a time t16, the scan line Y1 is set to a non-selected state. Thus, the TFT 7 of each of the R liquid crystal cells connected to the scan line Y1 is turned off, and the data signal of red (R) is held at the pixel electrode 8 of the R liquid crystal cell.

Next, at a time t17, the switch 22 is turned off, the switch 23 is turned on, and the image data of blue (B) is supplied into the level shifters 31 and 32. In the D/A conversion circuits 51 and 61, the gray scale voltages according to the image data are selected. At the same time, the scan line Y3 of the first scan group is selected. It should be noted that the scan line Y3 is a scan line connected to the B liquid crystal cells. In this state, the data signal V63p of the positive polarity of blue (B) is supplied to the data line X1, a data signal V63n of the negative polarity of blue (B) is supplied to the data line X2, and the TFT 7 connected to the selected scan line Y3 is turned on. Thus, a data signal of blue (B) is supplied to a pixel electrode 8 of each of the B liquid crystal cells.

Next, at time t18, the scan line Y3 is made unselected. Thereby, the TFT 7 of the B liquid crystal cell connected to the scan line Y3 is turned off, and the data signal of blue (B) is maintained at the pixel electrode 8 of the B liquid crystal cell.

Through the above procedure, the driving of the G liquid crystal cells connected to the scan line Y2, the R liquid crystal cells connected to the scan line Y1, and the B liquid crystal cells connected to the scan line Y3 is completed.

Next, at a time t19, the precharging of the data lines X1 and X2 is started again. In detail, the switches 52 and 62 are turned off, the switches 53 and 63 are turned on, and the D/A conversion circuits 51 and 61 are set up to be Hi-Z. The data line X1 that is supplied with the data signal of the positive polarity and the data line X2 that is supplied with the data signal of the negative polarity are precharged to GND.

A driving period of the G liquid crystal cell is a period TG from the time t11 to the time t14, a driving period TR of the R liquid crystal cell is a period TR from the time t14 to the time t17, and a driving period of the B liquid crystal cell is a period TB from the time t17 to the time t19. In the present embodiment, the liquid crystal cell 9 is so driven that the period TG, the period TR, and the period TB may be equal in time length.

Next, at a time t20, a second horizontal period is started. First, the switches 72 and 73 are turned on. When the switches 72 and 73 are turned on, a driving capability is improved since the switches 71 to 74 are in the on state at the same time, and the precharging of the data lines X1 and X2 to GND is accelerated.

Furthermore, at a time t20, the switch 21 is turned on, and the switch 23 is turned off. In addition, the image data is transferred to the latch circuits 11 and 12. Furthermore, the gray scale voltage generating circuits 55 and 65 are set to generate the gray scale voltages corresponding to the gamma curve of green (G). The image data of green (G) is supplied into the level shifters 31 and 32, and the gray scale voltages according to the image data are selected in the D/A conversion circuits 51 and 61.

Next, at a time t21, the switches 52 and 62 are turned on, the switches 53 and 63 are turned off, and the switches 71 and 74 are turned off. At the same time, the scan line Y5 of the second scan group is selected. In this state, the data signal V63n of the negative polarity of green (G) is supplied to the data line X1, the data signal V63p of the positive polarity of green (G) is supplied to the data line X2, and the TFT 7 connected to the scan line Y5 is turned on. Thus, the data signal of green (G) is supplied to the pixel electrode 8 of the G liquid crystal cell connected to the scan line Y5.

Next, at a time t23, the scan line Y5 is set to a non-selected state, the TFT 7 of each of the G liquid crystal cells connected to the scan line Y5 is turned off, and the data signal of green (G) is held at the pixel electrode 8 of the G liquid crystal cell.

Next, at a time t24, the switch 21 is turned off, and the switch 22 is turned on. Thus, the image data of red (R) is supplied into the level shifters 31 and 32, and the gray scale voltages according to the image data are selected in the D/A conversion circuits 51 and 61. At the same time, the scan line Y4 of the second scan group is selected. It should be noted that the scan line Y4 is a scan line connected to the R liquid crystal cells. The gray scale voltage generating circuits 55 and 65 are set to generate the gray scale voltages corresponding to the gamma curves of red (R) and blue (B), respectively. In this state, a data signal V0n of the negative polarity of red (R) is supplied to the data line X1, a data signal V0p of the positive polarity of red (R) is supplied to the data line X2, and the TFT 7 connected to the scan line Y4 is turned on. Thus, the data signal of red (R) is supplied to each pixel electrode of the R liquid crystal cell connected to the scan line Y4.

Next, at a time t26, the scan line Y4 is set to a non-selected state. Thus, the TFT 7 connected to the scan line Y4 is turned off, and the data signals of red (R) are held at the respective pixel electrodes 8 of the R liquid crystal cells connected to the scan line Y4.

Next, at a time t27, the switch 22 is turned off and the switch 23 is turned on. Thus, the image data of blue (B) is supplied into the level shifters 31 and 32 and the gray scale voltages according to the image data are selected in the D/A conversion circuits 51 and 61. At the same time, the scan line Y6 of the second scan group is selected. It should be noted that the scan line Y6 is a scan line connected to the B liquid crystal cells. In this state, the data signal V63n of the negative polarity of blue (B) is supplied to the data line X1, the data signal V63p of the positive polarity of blue (B) is supplied to the data line X2, and the TFT 7 connected to the scan line Y6 is turned on. Thus, the data signal of blue (B) is supplied to the pixel electrode 8 of each of the B liquid crystal cells connected to the scan line Y6.

Next, at a time t28, the scan line Y6 is set to a non-selected state. Thus, the TFT 7 connected to the scan line Y6 is turned off, and the data signal of blue (B) is held at the pixel electrode of the B liquid crystal cell.

Next, at a time t29, the switches 52 and 62 are turned off, the switches 53 and 63 are turned on, and the D/A conversion circuits 51 and 61 become Hi-Z. Thereby, the data line X1 that is supplied with a data signal of the negative polarity and the data line X2 that is supplied with a data signal of the positive polarity are precharged to GND.

After this operation, the same operations as those of the time t10 to the time t29 are repeatedly performed until the scan of the n^{th} scan group is completed.

In a next 2j^{th} frame period, the liquid crystal cell 9 is driven according to the same operation as that of the (2j−1)^{th} frame period except for a point that the polarities of the data signals applied to all the liquid crystal cells 9 are inverted.

Describing the above procedure briefly, in the first horizontal period, the scan lines Y1 to Y3 of the first scan group are scanned. In the scan of the first scan group, the scan lines Y1 to Y3 are selected in an order of the scan line Y2 corresponding to green (G), the scan line Y1 corresponding to red (R), and the scan line Y3 corresponding to blue (B). In the next second horizontal period, the scan lines Y4 to Y6 of the second scan group are scanned. In the scan of the second scan group, the scan lines Y4 to Y6 are selected in an order of the scan line Y5 corresponding to green (G), the scan line Y4 corresponding to red (R), and the scan line Y6 corresponding to blue (B). Similarly, in an i^{th} horizontal period, the scan lines Y(3i−2) to Y3i of the i^{th} scan group are scanned. In the scan of the i^{th} scan group, the scan lines Y(3i−2) to Y3i are selected in an order of: the scan line Y(3i−1) corresponding to green (G), the scan line Y(3i−2) corresponding to red (R), and the scan line Y3i corresponding to blue (B). All the data lines X1 to Xm are precharged to GND in a horizontal blanking period (a period from the time t9 to the time t11, a period from the time t19 to the time t21). Furthermore, the polarity of the data signal is inverted every horizontal period (every three scan periods). The polarity of the data signal differs between adjacent two data lines. The polarity of each pixel is inverted for every frame.

According to such a driving method, the color reproducibility can be improved. Since the liquid crystal cell 9 of green (G) is precharged to GND before the data signal is supplied, the cell is driven with such a voltage as is desired without being affected by the data signal supplied immediately before. Since human spectral luminous efficacy is high for a green color, it is effective for improvement of the color reproducibility to eliminate an influence of the data signal that was supplied immediately before in driving the liquid crystal cell 9 of green (G). On the other hand, the driving of the liquid crystal cells 9 of red (R) and blue (B) is affected by the preceding data signal. For example, in order to display the cyan raster pattern, it is ideal that the liquid crystal cells 9 of green (G), red (R), and blue (B) are driven at the voltages V63, V0, and V63, respectively. However, due to the influence of the preceding data signal, for example, a voltage held by the liquid crystal cell 9 of red (R) becomes a voltage V2 corresponding to a gray scale level which is brighter by two gray scale levels, and the voltage held by the liquid crystal cell 9 of blue (B) becomes a voltage V61 corresponding to a gray scale level being darker by two gray scale levels. However, since the liquid crystal cells 9 of red (R) and blue (B) have lower spectral luminous efficacies than the liquid crystal cell 9 of green (G), a brightness difference caused by a change from the original voltage is hard to recognize. Therefore, there is a little influence upon the color reproducibility.

In addition, the driving method of the present embodiment uses 3G inversion drive in which the polarities of the data signals are inverted between the adjacent data lines, and are inverted every horizontal period (namely, every three scan periods). The adoption of the 3G inversion drive is effective in suppression of the flicker in the vertical stripe pattern and cross talk in the window pattern that are problems in the column inversion drive.

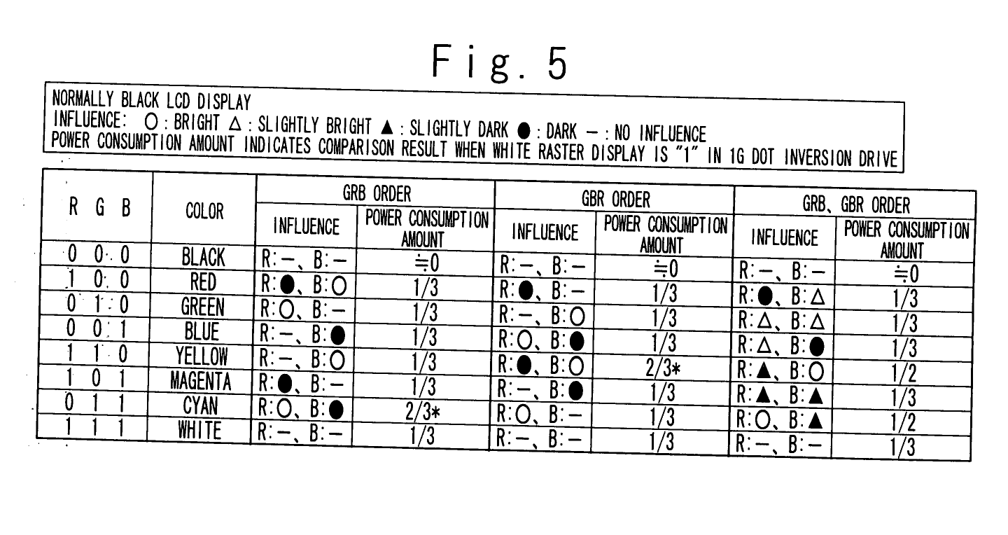

The column of “GRB Order” of a table of FIG. 5 indicates a degree of the influence of the preceding data signal and current consumed due to the data line when the scan line corresponding to green (G), the scan line corresponding to red (R), and the scan line corresponding to blue (B) are driven in this order in the scan of each scan group. It is assumed that the color filter is in the horizontal stripe arrangement of red (R), green (G), and blue (B) from the top and the liquid crystal of the liquid crystal cells 9 is normally black. The consumed current amount is considered based on that of a white raster pattern in dot inversion drive (1G inversion drive). In the determination of the degree of influence, when voltage shifts by two gray scale levels, it is determined that actual brightness of the liquid crystal cell 9 has become “bright” or “dark”, and when the voltage shifts by one gray scale level, it is determined that actual brightness of the liquid crystal cell 9 has become “slightly bright” or “slightly dark”. Here, it should be noted that there is a case that the voltage shifts by three gray scale levels or more depending on the number of pixels, a frame frequency, a driving voltage, etc. When a red raster pattern is displayed on the liquid crystal display panel 2, the image data of red (R) is 3Fh and the image data of blue (B) and green (G) is 00h. In this case, the voltage of the data signal supplied to the data line is the voltage V63 in the driving of the liquid crystal cell 9 of red (R), and is the voltage V0 in the driving of the liquid crystal cells 9 of green (G) and blue (B). However, FIG. 5 indicates that the voltage held by the liquid crystal cell 9 of red (R) becomes the voltage V61 corresponding to a gray scale level being darker by two gray scale levels due to influence of the data signal of green (G) (the voltage level V0), whereas the voltage held by the liquid crystal cell 9 of blue (B) becomes the voltage V2 corresponding to a gray scale level being brighter by two gray scale levels due to influence of the data signal of red (R) (the voltage level V63). The description about other display colors is omitted.

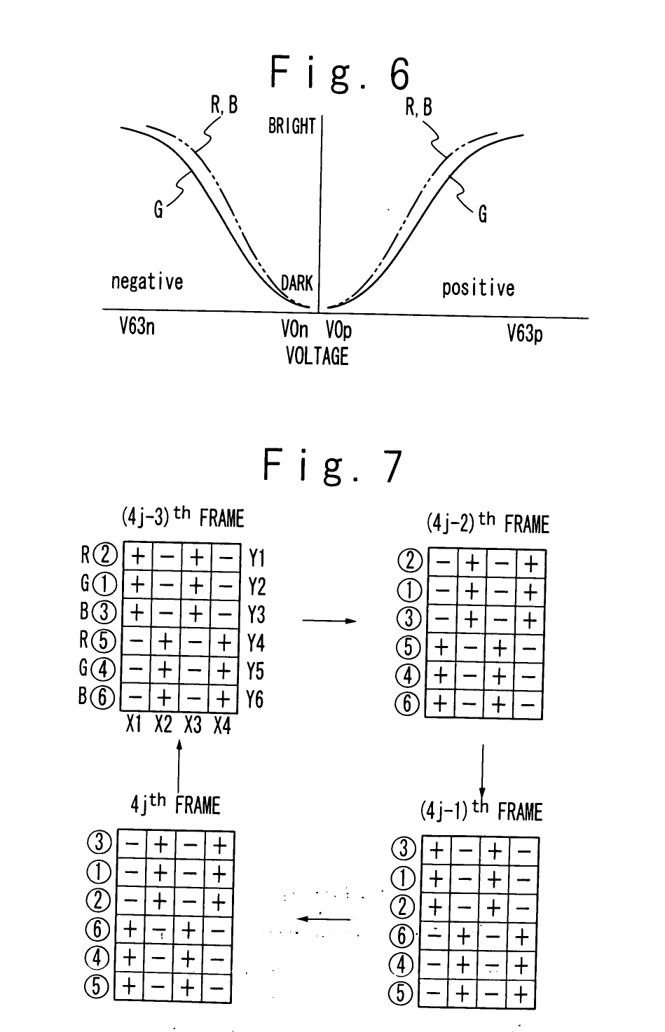

When the liquid crystal display panel 2 of the horizontal stripe arrangement is driven, the gray scale voltage generating circuits 55 and 65 of the data driver IC 3 can cope with both setting of generating a gray scale voltage corresponding to the gamma curve of green (G) and a setting of generating gray scale voltages that correspond to the gamma curves of red (R) and blue (B). The setting to be used is switched depending on time. In the driving of the liquid crystal cell 9 of green (G), the voltage level of the data line becomes the negative polarity or positive polarity from a GND level. That is, it is determined in advance whether the voltage level of the data line increases or decreases. Since voltage difference from GND is small at the minimum brightness voltage V0, a correction amount by the gamma curve is small, whereas since the voltage difference from GND is large at the maximum brightness voltage V63, the correction amount by the gamma curve is large. On the other hand, in the driving of the liquid crystal cells 9 of red (R) and blue (B), since the driving is affected by the preceding data signal, it is not determined in advance whether the voltage level of the data line increases or decreases. Accordingly, the voltage level of the data signal cannot be corrected uniformly. Therefore, as shown in FIG. 6, a voltage amplitude of the gamma curve of green (a difference between the minimum brightness voltage V0 and the maximum brightness voltage V63) is larger than voltage amplitudes of the gamma curves of red (R) and blue (B). According to the present embodiment, the liquid crystal cell 9 of green (G) whose spectral luminous efficacy is high can realize a color close to an ideal value by four adjustments of a precharge voltage, a precharge period, the driving period by the data signal corresponding to the image data, and the gamma curve.

Next, the consumed current amount will be described. In the dot inversion drive (the 1G inversion drive), when the liquid crystal is normally black, the consumed current amount becomes a maximum in the white raster pattern. The consumed current amounts in the column inversion drive and the 3G inversion drive will be described using the consumed current amount in the data line at this time as a reference (to be referred to as a reference current later). In the column inversion drive, it is a raster pattern free from variation of the voltage that the consumed current amount in the data line is minimum. Contrary to this, the consumed current amount becomes maximum in case of a magenta and green horizontal stripe pattern and in case of a magenta and green checker pattern. However, the consumed current amount is only about a half of the reference current in case of the 1G inversion drive of the white raster pattern.

In the 3G inversion drive of the present embodiment, the display pattern that maximizes the consumed current amount is the cyan raster pattern, and the consumed current amount is about ⅔ of the reference current. Therefore, a maximum consumed current amount becomes larger in a sequence of (column inversion drive<3G inversion drive<1G inversion drive).

Since due to the adoption of the horizontal stripe arrangement, the scan line increases threefold, a load capacitance of the data line increases, and a driving frequency becomes threefold; the consumed current amount of the data driver IC 3 increases, to generate heat. Portions where the consumed current amount is large inside the data driver IC 3 are the level shifters 31 and 32 and the D/A conversion circuits 51 and 61. When the image data is inverted, transient currents flow in the level shifters 31 and 32, which increase the consumed current amount. Since the D/A conversion circuits 51 and 61 include amplifiers such as voltage followers, the consumed current amount becomes large. Since the power consumption amount is proportional to a square of a power supply voltage, it is effective to lower the power supply voltage. Therefore, in the present embodiment, the positive electrode driving circuit 50 and the negative electrode driving circuit 60 are operated with separate power supply voltages.

In addition, it is desirable that the voltage amplitude of the data signal of the positive polarity generated by the positive electrode driving circuit 50 differs from the voltage amplitude of the data signal of the negative polarity generated by the negative electrode driving circuit 60. A threshold voltage Vt of the TFT 7 of the each liquid crystal cell 9 depends on a voltage level Vd of the data signal and is expressed by Vt=Vd+Vt0. In this equation, Vt0 is a threshold voltage not depending on the voltage level Vd of the data signal. If the TFT 7 is of an n-type, the threshold voltage Vt in case of the data signal of the positive polarity becomes higher than the threshold voltage Vt in case of the data signal of the negative polarity. Therefore, because of rounding of the scan signal, a turn-on period becomes short in the positive electrode, and a write efficiency to the pixel electrode 8 decreases. A fact that a feed-through error of the TFT 7 is large for the data signal of the positive polarity is also one of reasons why it is desirable that the data signal of the positive polarity and the data signal of the negative polarity should be different from each other in voltage amplitude. Representing the capacitance of the liquid crystal cell 9 by Cc, and a gate capacitance of the TFT 7 by Cg, and an off voltage of the gate voltage of the TFT 7 by Vgoff, a feedthrough error ΔV is expressed by ΔV=(Vgoff−Vt)×Cg/(Cc+Cg). The data signal of the positive polarity having a large voltage difference from the off voltage Vgoff gives rise to a large feedthrough error. In order to correct these factors, the voltage amplitude of the data signal of the positive polarity is made larger than the voltage amplitude of the data signal of the negative polarity.

The scan in each scan group may be performed in an order of the scan line corresponding to green (G), the scan line corresponding to blue (B), and the scan line corresponding to red (R). A column of “GBR Order” of the table of FIG. 5 indicates the degree of the influence of the preceding signal and the consumed current amount in the data line when the scan line corresponding to green (G), the scan line corresponding to blue (B), and the scan line corresponding to red (R) are driven in this order in the scan of each scan group. In this case, the display pattern that maximizes the consumed current amount is a yellow raster pattern, and the consumed current amount is about ⅔ that of the reference current.

Although in the present embodiment, the reference voltage has been described as the system ground voltage GND, the reference voltage may be VDD/2 (a half of VDD). If VDD=12 V, the reference voltage is 6 V, VPH=12 V, and VNL=0 V, and the positive electrode is in a voltage range of 6 V to 12 V, and the negative electrode is in the voltage range 0 V to 6 V. What is necessary is just to designate an electrode whose voltage is higher than the reference voltage as the positive electrode and to designate an electrode whose voltage is lower than the reference voltage as the negative electrode.

### Second Embodiment

In a second embodiment, although it is the same as the first embodiment that a scan line corresponding to green (G) is first selected in the each scan group immediately after the precharge, the scan order of a scan line corresponding to red (R) and a scan line corresponding to blue (B) is changed every two frame periods. The selection order of the scan lines corresponding to red (R) and the scan line corresponding to blue (B) may be changed every two horizontal periods and every two frame periods.

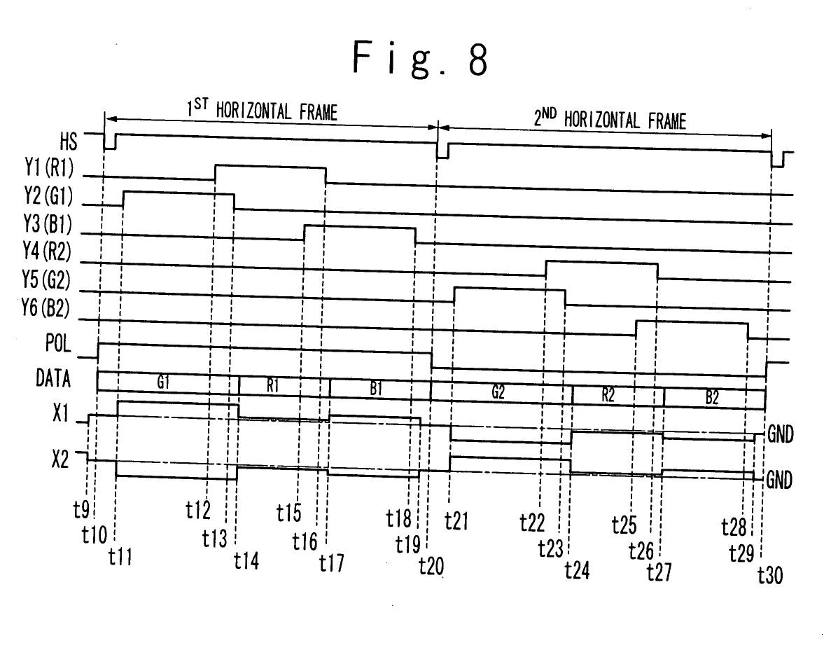

FIG. 7 is a conceptual diagram showing a method for driving the liquid crystal cell 9 in the second embodiment. In a (4j−3)^{th} frame period and a next (4j−2)^{th} frame period, the scan lines of the each scan group are driven in an order of the scan line corresponding to green (G), the scan line corresponding to red (R), and the scan line corresponding to blue (B). More specifically, a scan sequence of the scan lines Y1 to Y3n is an order of the scan lines Y2, Y1, Y3, Y5, Y4, Y6, . . . , Y(3i−1), Y(3i−2), Y3i, . . . , Y(3n−1), Y(3n−2), and Y3n.

On the other hand, in a next (4j−1) th frame period and a second next 4j^{th} frame period, the scan lines of each scan group are driven in an order of the scan line corresponding to green (G), the scan line corresponding to blue (B), and the scan line corresponding to red (R). More specifically, the scan order of the scan lines Y1 to Y3m is an order of the scan line Y2, Y3, Y1, Y5, Y6, Y4, . . . , Y(3j−1), Y3i, Y(3i−2), . . . , Y(3n−1), Y3n, and Y(3n−2).

The timing control circuit of the data driver IC 3 supplies a switch signal to the multiplexer 20 inside the IC and the scan line driving circuit 5 of the liquid crystal display panel 2, and thereby brings the data signal and the scan order of the scan lines into right correspondence with each other. In response to a switch signal, the scan line driving circuit 5 switches the scan order of the scan line corresponding to red (R) and the scan line corresponding to blue (B). A circuit for switching the scan order is realized by arranging a switching circuit for switching signals from the shift register section, between the shift register section and the output buffer section of the scan line driving circuit 5. As will be described below, it is effective for improvement of the color reproducibility to switch the scan order of the scan line corresponding to red (R) and the scan line corresponding to blue (B).

With reference to FIG. 5, the color reproducibility and the power consumption amount in the driving method of the second embodiment will be described. The column of “GRB, GBR Order” in the table of FIG. 5 indicates the degree of the influence of the preceding data signal and the consumed current amount in the data line when the scan order of the scan line corresponding to red (R) and the scan line corresponding to blue (B) is switched every two frame periods. For example, in order to display a green raster pattern, it is ideal that the liquid crystal cells 9 of red (R), green (G), and blue (B) are driven by the voltages V0, V63, and V0, respectively. If the scan order of each scan group is fixed to an order of the scan line corresponding to green (G), the scan line corresponding to red (R), and the scan line corresponding to blue (B), a voltage held by the liquid crystal cell of red (R) becomes V2 of making the cell brighter by two gray scale levels due to the influence of the preceding data signal. Since the preceding data signal is V0 of red (R), the voltage held by the liquid crystal cell of blue (B) is not affected. On the other hand, when the scan orders of all the scan groups are fixed as an order of the scan line corresponding to green (G), the scan line corresponding to blue (B), and the scan line corresponding to red (R), the voltage held by the liquid crystal cell 9 of blue (B) becomes the voltage V2 corresponding to a gray scale level being brighter by two gray scale levels due to the influence of the preceding data signal, whereas the voltage held by the liquid crystal cell 9 of red (R) is not affected because the preceding data signal is V0 of blue (B). Therefore, when the scan order of the scan line corresponding to red (R) and the scan line corresponding to blue (B) is switched every two frame periods, respective actual brightnesses of the liquid crystal cell 9 of red (R) and the liquid crystal cell 9 of blue (B) are averaged. The liquid crystal cell 9 of red (R) becomes brighter by one gray scale level, and the liquid crystal cell 9 of blue (B) becomes brighter by one gray scale level. Thus, if the scan order of the scan line corresponding to red (R) and the scan line corresponding to blue (B) is changed, the degree of the influence of the preceding data signal spreads out and the color reproducibility is improved.

Also, the consumed current amount of the data signal becomes maximum when a raster pattern of yellow is displayed in the frame period of the GBR order or a raster pattern of cyan is displayed in the frame period of the GRB order. By switching the GRB order and the GBR order for every 2 frames, the consumed current amount becomes about ½ of the reference current amount when displaying the raster pattern of yellow or cyan. This amount is the same as the maximum consumed current in the data signal of the column reverse drive. In other words, according to the 3G inverting drive of this embodiment, the maximum consumed current amount is the same as that of the column inversion drive, and can improve a picture quality.

In the second embodiment described above, the scan order of the scan lines is switched for every two frame periods. However, the scan order may be switched for every one frame period. For example, the scan orders of the (4j−3)^{th} frame period and the 4j^{th} frame period are switched for every one frame period, or the scan orders of the (4j−2)^{th} frame period and the (4j−1)^{th} frame period may be switched for every one frame period.

### Third Embodiment

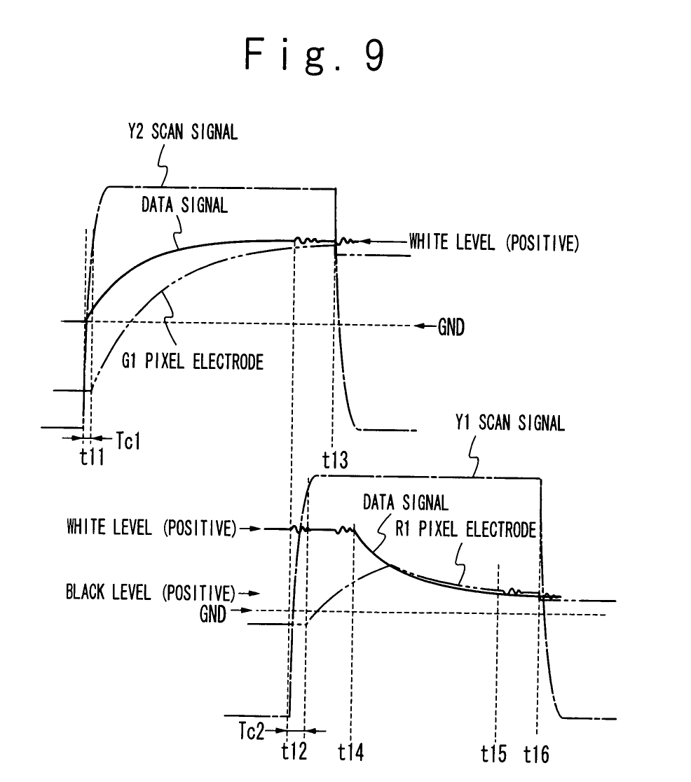

In a third embodiment, it is prevented that by preliminarily scan the scan lines of green (G), red (R), and blue (B) and making their scan periods overlap one another, the driving periods of the pixel electrodes 8 in the liquid crystal cells 9 of red (R) and blue (B) become short. More specifically, as shown in FIG. 8, a scan period (a period from the time t11 to the time t13) of the scan line Y2 corresponding to green (G) and a scan period (a period from the time t12 to the time t16) of the scan line Y1 corresponding to red (R) overlap in the period from the time t12 to the time t13. Similarly, a scan period (a period from the time t12 to the time t16) of the scan line Y1 corresponding to red (R) and a scan period (a period from the time t15 to the time t18) of the scan line Y3 corresponding to blue (B) overlap in the period from the time t15 to the time t16.

In the first embodiment described above, the driving period TG (a period from the time t11 to the time t14) of the liquid crystal cell 9 of green (G), the driving period TR (a period from the time t14 to the time t17) of the liquid crystal cell 9 of red (R), and the driving period TB (a period from the time t17 to the time t19) of the liquid crystal cell 9 of blue (B) have a same length. However, in the third embodiment, the lengths of the driving periods TG, TR, and TB may differ from one another. For example, the lengths of the driving periods TG, TR, and TB may be such that TG>TR=TB, TG>TR>TB, TG<TR=TB, TR>TG>TB, or the like. In FIG. 8, the driving period TG of the liquid crystal cell 9 of green (G) is set longer than the driving periods TR, TB of the liquid crystal cells 9 of red (R) and blue (B).

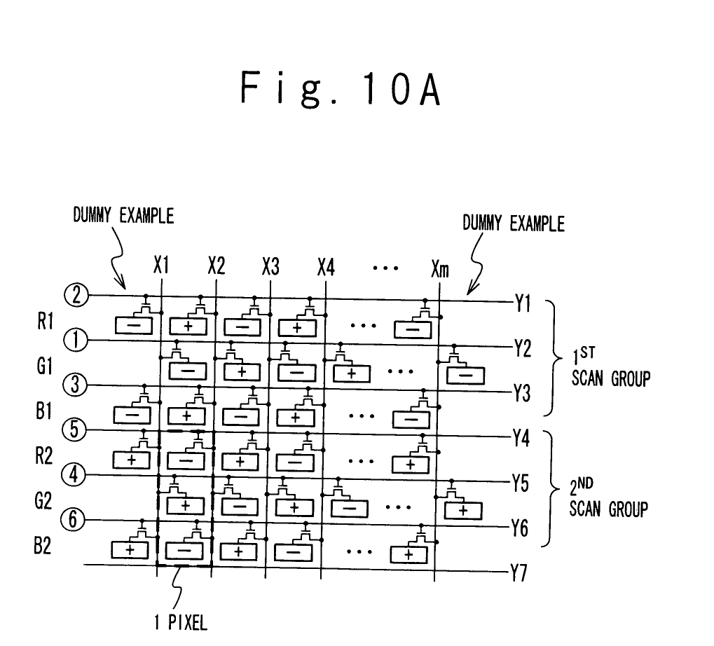

A timing of overlap will be described with reference to timing charts of FIG. 9. When the scan periods of the scan lines of green (G), red (R), and blue (B) are made to overlap, coupling noise from the scan lines occurs in the data line. If a period from the time t12 to the time t13 is too short, the liquid crystal cell 9 exhibits display unevenness since the noise does not converge. However, if an overlap period is too long, the color reproducibility degrades. In the vicinity of a middle gray scale level (the voltage V32 and its neighborhood), if a direction of variation of the voltage of the pixel electrode 8 varies until the middle gray scale level is achieved, the brightness difference is easily recognized. Therefore, it is desirable that at the time t14, the overlap period is set so that the voltage of the pixel electrode 8 may become a gray scale level of ¼ to ⅓ of the maximum gray scale number so as not to exceed the middle gray scale level or so (the voltage V16 to the voltage V22 or its neighborhood). In the third embodiment, since write periods to the pixel electrodes 8 of the liquid crystal cells 9 of red (R) and blue (B) can be made long compared with the first embodiment, it is possible to improve the color reproducibilities of red (R) and blue (B).

If the scan periods of the scan line Y3 of blue (B) of the first scan group and of the scan line Y5 of green (G) of the second scan group are made to overlap each other, the pixel electrode of green (G) is preliminarily charged to the opposite polarity, to degrade the color reproducibility, since the polarities of the data signals are different. Therefore, the overlap including a period in which the polarity of the data signal inverts is not desirable.

When the coupling noise is slow to converge and display unevenness arises, it is not desirable that the scan periods of the scan lines of green (G), red (R), and blue (B) are made to overlap one another. It is rather desirable to lengthen the driving periods TR and TB of red (R) and blue (B) so that the lengths of the driving periods TG, TR, and TB may hold a relation of TG<TR=TB, and thereby to improve the color reproducibilities of red (R) and blue (B).

Alternatively, it is all right that the lengths of the driving periods TG, TR, and TB are adjusted so that a relation of TR>TG>TB may be established. As an example of this, it is desirable to lengthen the driving period of red (R) just by the time required to change the gamma curves. Settings of the gamma curve of green (G) to the gray scale voltage generating circuits 55 and 65 are completed in a period in which the data lines are precharged to GND.

### Fourth Embodiment

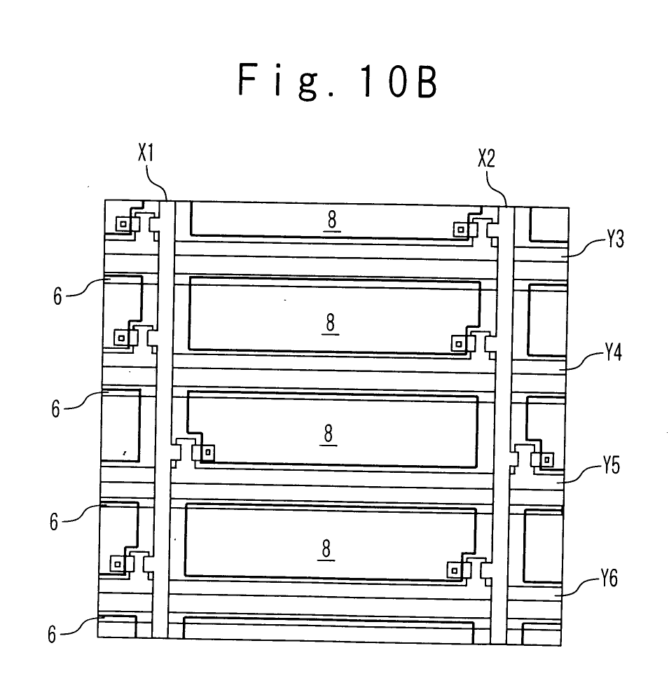

As shown in FIG. 10A, in a fourth embodiment, the liquid crystal cell 9 that is connected to the central scan line of each scan group and is connected to the data line Xk is provided on the opposite side to the liquid crystal cell 9 that is connected to another scan line of the scan group and is connected to the same data line Xk, with respect to the data line Xk. The liquid crystal cell 9 on a left side of the left end data line X1 and the liquid crystal cell 9 on a right side of the right end data line Xm are light shielded, and these liquid crystal cells 9 function as dummy cells that are practically not used for display. The dummy cells are provided to equalize parasitic capacitances of the data line X1 and the data line Xm to those of other data lines.

In the example of FIG. 10A, the liquid crystal cell 9 of green (G) is located on the opposite side to the liquid crystal cells 9 of red (R) and blue (B) connected to the same data line with respect to the data line. The pixel electrodes 8 of the liquid crystal cells 9 of red (R) and blue (B) connected to the data line Xk are supplied with the data signals through the TFT 7 arranged on a left side of the data line Xk. On the other hand, the liquid crystal cell 9 of green (G) connected to the data line Xk is supplied with the data signal through the TFT 7 arranged on a right side of the data line Xk. In other words, the liquid crystal cell 9 connected with the scan line Y(3i−1) of the i^{th} scan group is supplied with a data signal through TFT 7 which is arranged on the right side of the data line Xk. On the other hand, the liquid crystal cells 9 connected with scan lines Y(3i−2) and Y3i are supplied with the data signals through TFTs 7 which are arranged on the left side of data line Xk. In the fourth embodiment, if the 3G inversion drive is performed similarly to the first embodiment, dot inversion display can be performed in false, and therefore an image quality is improved. The data signals may be supplied to the liquid crystal cells 9 of red (R) and blue (B) connected to the data line Xk through the TFT 7 arranged on the right side of the data line Xk, and the data signal may be supplied to the liquid crystal cell 9 of green (G) connected to the same data line Xk through the TFT arranged on the left side of the data line Xk.

Even if an order of the colors of the color filters is not RGB but any one of RBG, GRB, GBR, BRG, or BGR, what is necessary is just to provide the liquid crystal cell 9 that is connected to the scan line located in the center of each scan group and is connected to the data line Xk, to be on the opposite side to the liquid crystal cell 9 that is connected to another scan line of the scan group and is connected to the data line Xk with respect to the data line Xk. However, in any arrangement of colors of the color filters, the liquid crystal cell 9 of green (G) is first selected in the each scan group immediately after the precharge.

FIG. 10B shows a layout of the liquid crystal cells. The scan line Y extending in a horizontal direction and an auxiliary capacitance line 6 are formed in a same layer. The data line X extending in vertical direction is formed in an upper layer of the layer in which the scan line Y and the auxiliary capacitance line 6 are formed. Also, a second auxiliary capacitance line (not shown) is provided between the scan line y and the pixel electrode 8 in the same layer as the data line for each liquid crystal cell 9 to have a capacitance function and a shield function. The auxiliary capacitance is formed between the pixel electrode 8 and the second auxiliary capacitance line. The auxiliary capacitance line 6 may extend in the same direction as the data line X and the vertical direction, and the second auxiliary capacitance line may be branched from the auxiliary capacitance line in the horizontal direction for every liquid crystal cell 9.

### Fifth Embodiment

In the first to fourth embodiments, the scan order of scan lines in each scan group is the order of the G scan line (first scan line) immediately after the precharge, the R scan line (second scan line) and the B scan line (third scan line) (hereinafter, to be referred to as the GRB order), or the order of the G scan line (first scan line), the B scan line (second scan line) and the R scan line (third scan line) (hereinafter, to be referred to as the GBR order). In the fifth embodiment of the present invention, the GRB order and the GBR order are mixed in one frame period. The fifth embodiment will be described by taking as an example, a combination with the fourth embodiment, I.e. the arrangement in the different position, of the TFT of liquid crystal cell 9 at the center of each scan group capable of the quasi dot inverting display by the 3G inverting drive.

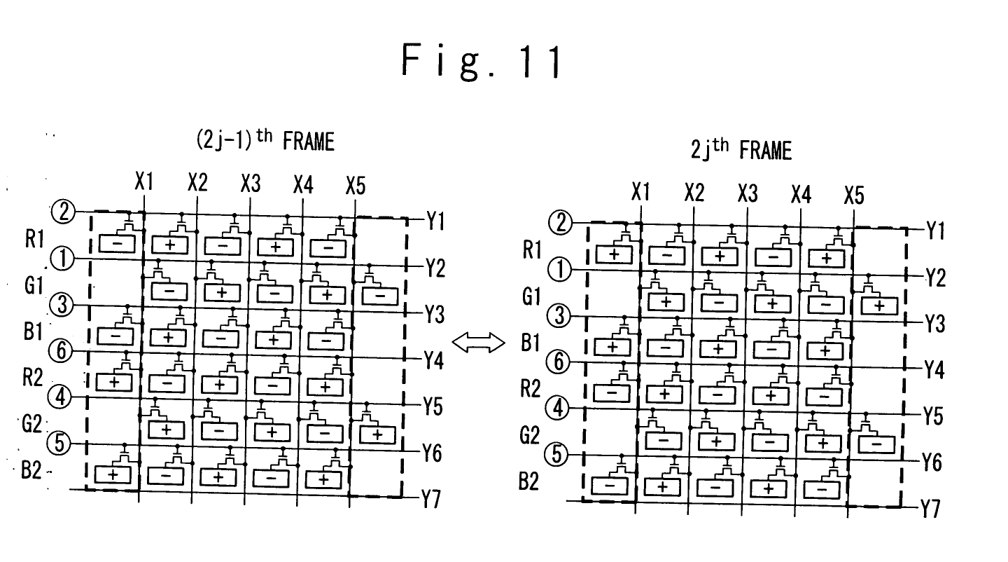

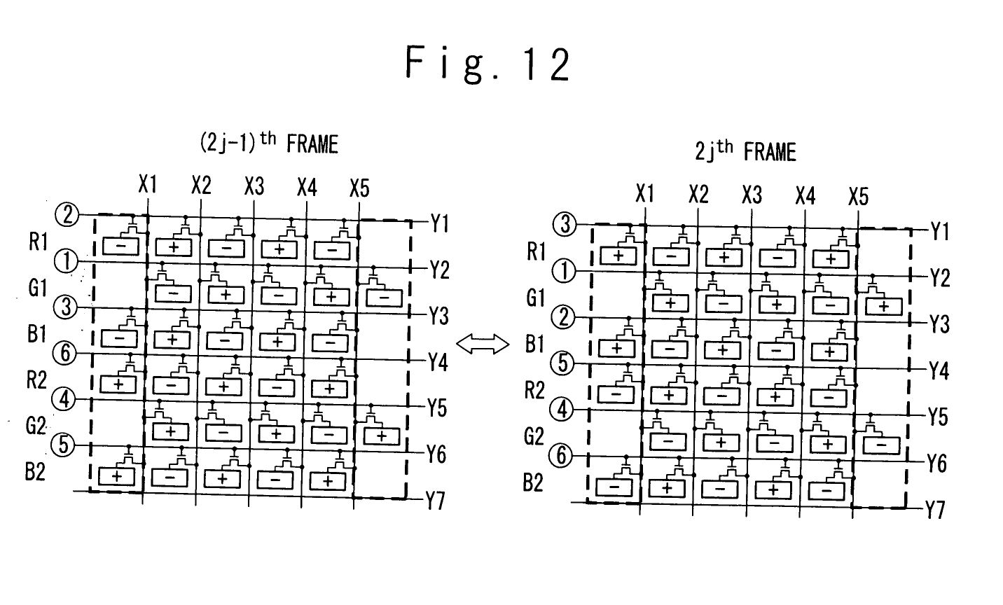

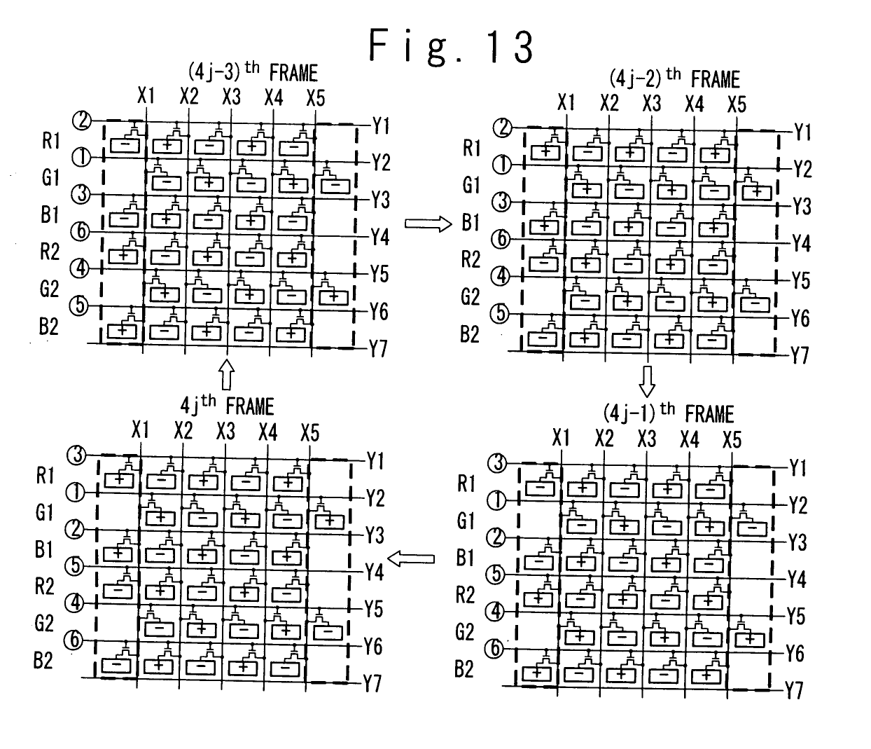

There are the following six combinations of scan orders in which the GRB order and the GBR order are mixed for every one or two horizontal periods in one frame period (namely, every three or six scan periods), or every one or two frame periods:
(I) every one horizontal period (FIG. 11),
(II) every one horizontal period and every one frame period (FIG. 12),
(III) every horizontal period and every two frame period (FIG. 13),
(IV) every two horizontal periods,
(V) every two horizontal periods and every one frame period, and
(VI) every two horizontal periods and every two frame period.

In the scan order (I) shown in FIG. 11, odd-numbered scan groups are driven in the GRB order and even-numbered scan groups are driven in the GBR order. In other words, the order of the colors in the liquid crystal cell is G→R→B→G→B→R and this order is repeated. According to this scan order, the pattern in which the consumed current amount due to the data signal is maximum is cyan and yellow horizontal stripe pattern and the consumed current amount is ⅔ of the reference electric current amount. In this way, the pattern for the maximum consumed current amount can be changed by switching the scan orders. In the display pattern for the maximum consumed current amount, the temperature of data driver IC 3 becomes high. If the high temperature state of the data driver IC 3 continues for a long time, there is a possibility that the image quality is degraded because the drive ability is lowered. Therefore, it is desirable that an occurrence frequency of the display pattern for the maximum consumed current amount is suppressed to be low. With the voltage polarity of the liquid crystal cell 9, the image quality is superior in the line inverting drive (line) rather than in the frame inverting drive (plane). Therefore, by changing the color influenced with the preceding data signal for every one scan group, it is possible to disperse the influence of the preceding data from the plane to the line. It should be noted that the scan order may be G→B→R→G→R→B in which the odd-numbered scan groups are driven in the GBR scan order and the even-numbered scan groups are in the GRB scan order.

In the scan order (II) shown in FIG. 12, in the (2j−1)^{th} frame period, the odd-numbered scan groups are driven in the GRB scan order and the even-numbered scan groups are driven in the GBR order. In other words, the order of the colors of the liquid crystal cell to be driven is G→R→B→G→B→R, which is the same as the scan order of FIG. 11. The pattern for the maximum consumed current amount is a horizontal stripe pattern in the order of cyan and yellow under assumption that the liquid crystal is normally black. However, in the second 2j^{th} frame period, the odd-numbered scan groups are driven in the GBR order and the even-numbered scan groups are driven in the GRB order. In other words, the order of the colors of the liquid crystal cell to be displayed is G→B→R→G→R→B. The maximum consumed current amount pattern is a horizontal stripe patter in the order of yellow and cyan.

In the scan order (III) shown in FIG. 13, the order of the colors of the liquid crystal cell to be displayed is G→R→B→G→B→R in (4j−3)^{th} and the (4j−2)^{th} frame periods. The maximum consumed current amount pattern is a horizontal stripe pattern in the order of cyan and yellow under the assumption that the liquid crystal is normally black. The order of the colors of the liquid crystal cell to be displayed is G→B→R→G→R→B in (4j−1)^{th} and fourth 4j^{th} frame periods. The maximum consumed current amount pattern becomes a horizontal stripe pattern of in the order of yellow and.

According to the scan orders of FIGS. 12 and 13, the scan orders are switched in such a manner that the maximum consumed current amount pattern is different for every one or two frames, and as the result of this, the maximum consumed current amount can be made about ½ of the reference current amount. Also, the influence of the preceding data signal can be dispersed temporally and spatially by switching the scan orders in each scan group for every one scan group and every one frame period.

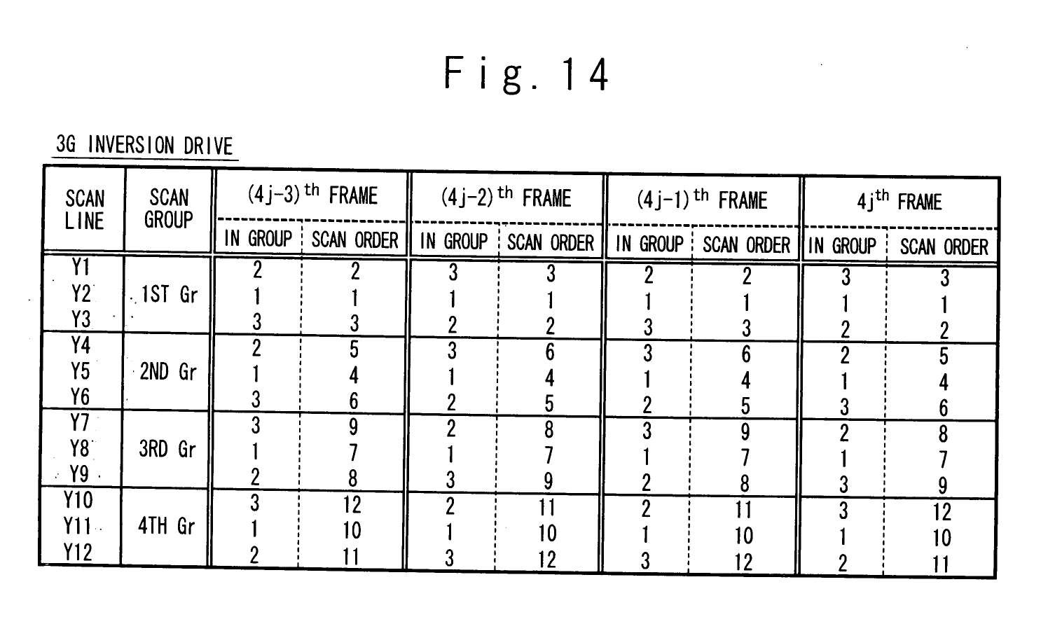

The descriptions of the scan orders (IV), (V) and (VI) are the same as those of the scan orders (I), (II) and (III) by switching the GRB scan order and the GBR scan order for every two horizontal periods. Therefore, the description is omitted. FIG. 14 shows a table of the scan order in a modification of scan order (V). The first and second scan groups in the (4j−3)^{th} frame period are the GRB scan order and the third and fourth scan groups are the GBR scan order. The maximum consumed current amount pattern in this case is a horizontal stripe pattern of cyan, cyan, yellow, and yellow. The first and second scan groups in the (4j−2)^{th} frame period are the GBR scan order and the third and fourth scan groups are the GRB scan order. The maximum consumed current amount pattern in this case is a horizontal stripe pattern of yellow, yellow, cyan, and cyan. The first and fourth scan groups in the (4j−1)^{th} frame period are the GRB scan order and the second and third scan groups are the GBR scan order. The maximum consumed current amount pattern in this case is a horizontal stripe pattern of cyan, yellow, yellow, and cyan. The first and fourth scan groups in the fourth 4j^{th} frame period are the GBR scan order and the second and third scan groups are the GRB scan order. The maximum consumed current amount pattern in this case is a horizontal stripe pattern of yellow, cyan, cyan, and yellow. In this way, the GRB order or the GBR order may give way every two scan group.

### Sixth Embodiment

The sixth embodiment is different from the first embodiment in that two data lines are provided for one column and two scan lines are selected at the same time. However, the number of liquid crystal cells 9 which are connected with one data line is 3n/2 which is a half of the number of liquid crystal cells (or the number of scan lines) for one column which is 3n. Here, n is a multiple of 2. The number of data lines increases twice compared with the techniques of the first to fifth embodiments of the present invention. However, since two scan lines can be selected at the same time in one scan period, the one scan period becomes twice in long and can improve the write time of the data signal to the pixel electrode.

Also, in this embodiment, one scanning group is composed of six continuously arranged scan lines. Six scan lines from a scan line Y1 to a scan line Y6 which are continuous are referred to a first scanning group. Six scan lines from a scan line Y7 to a scan line Y12 which are continuous are referred to a second scanning group. Hereinafter, in the same way, six scan lines from a scan line Y(6i-5) to a scan line Y6i is referred to an i^{th} scanning group. Here, i is a natural number. When the liquid crystal display panel 2 has the number of pixels corresponding to WXGA, i is an integer from 1 to 384. The scan lines are selected in order of the first scanning group, the second scanning group, . . . , the (n/2)^{th} scanning group in this embodiment. It should be noted that the relation between the scan group and the scanning group indicates that the first and second scan groups are the first scanning group and the third and fourth scan groups are the second scanning group.

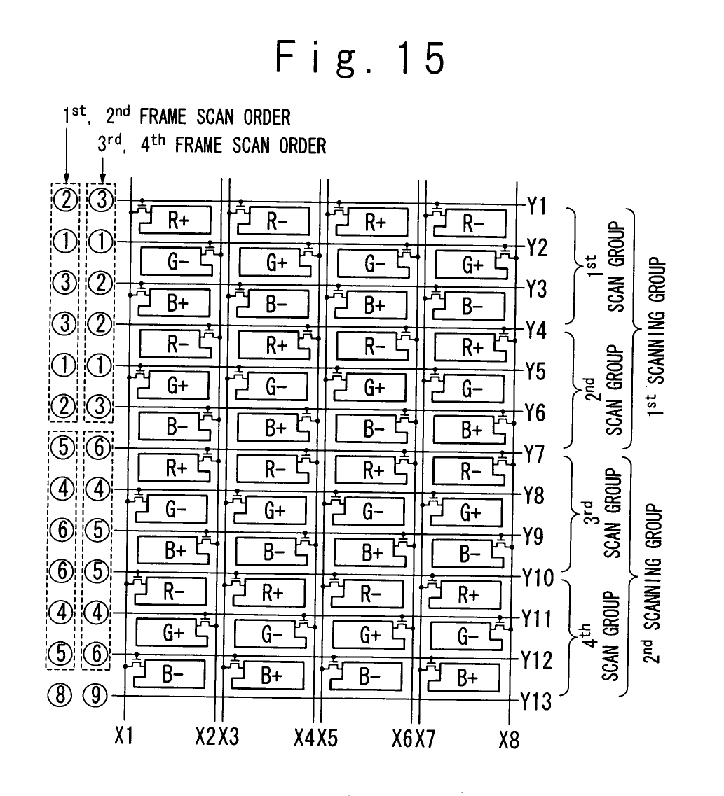

Next, connection relation between each liquid crystal cell 9 and data line will be described with reference to FIG. 15. First, connection between the first column of liquid crystal cells 9 and data lines X1 and X2 will be described. In the first scanning group, an R liquid crystal cell of a first row, a B liquid crystal cell of a third row, a G liquid crystal cell of a fifth row are connected with the data line X1, and a G liquid crystal cell of a second row, an R liquid crystal cell of a fourth row, a B liquid crystal cell of a sixth row are connected with the data line X2. In the second scanning group, an R liquid crystal cell of a seventh row, a B liquid crystal cell of a ninth row, a G liquid crystal cell of an eleventh row are connected with the data line X2 and a G liquid crystal cell of an eighth row, an R liquid crystal cell of a tenth row, and a B liquid crystal cell of a twelfth row are connected with the data line X1. A thirteenth row and the subsequent are connected with the data lines X1 and X2 in the same way as the first to twelfth rows. Also, the liquid crystal cells 9 in the second column and the subsequent are connected in the same way as the first column. Although not illustrated, the connection relation may be opposite in the odd-numbered column and the even-numbered column.

In this embodiment, all the data lines X1 to X2m are precharged to a predetermined reference voltage in the blanking period of the two horizontal periods. Immediately after the precharge, the G scan line is selected and a data signal is supplied to the G liquid crystal cell. Here, two scan lines are selected at a same time. Also, each control signal is controlled for in units of the two horizontal periods. For example, the latch signal STB is generated for every two horizontal periods. One scan period is about ⅔ of the horizontal period, and the two horizontal periods is composed of a blanking period and three scan periods.

Next, the scan order of the scan lines will be described. The G scan lines Y2 and Y5 are first selected at a same time in the start of first two horizontal periods in the (4j−3)^{th} and (4j−2)^{th} frame periods. Subsequently, the R scan line Y1 and B scan line Y6 are selected at a same time. Then, the B scan line Y3 and the R scan line Y4 are selected at a same time. Next, the G scan lines Y8 and Y11 are selected at a same time in the start of second two horizontal periods. Subsequently, the R scan line Y7 and the B scan line Y12 are selected at a same time. Then, the B scan line Y9 and the R scan line Y10 are selected at a same time. Paying attention only to the colors of the liquid crystal cells, the above scan order in the first and second scanning groups is GG→RB→BR→GG→RB→BR.

The G scan lines Y2 and Y5 are selected at a same time in the start of first two horizontal periods in (4j−1)^{th} and 4j^{th} frame periods. Subsequently, the B scan line Y3 and the R scan line Y4 are selected at a same time. Then, the R scan line Y1 and the B scan line Y6 are selected at a same time. Next, the G scan lines Y8 and Y11 are selected at a same time in the start of second two horizontal periods. Subsequently, the B scan line Y9 and the R scan line Y10 are selected at a same time. Then, the R scan line Y7 and the B scan line Y12 are selected at a same time. Paying attention only to the colors of the liquid crystal cells, the scan order of the first and second scanning groups is GG→BR→RB→GG→BR→RB. According to the scan order of FIG. 15, the G scan lines in the same scanning group are selected at a same time, and the R scan line and the B scan lines of the different scan groups in the same scanning group are selected at a same time. As described in the first embodiment, the gamma curves for red (R) and blue (B) of the liquid crystal cell 9 are same and therefore the R liquid crystal cell and the B liquid crystal cell may be selected at a same time.

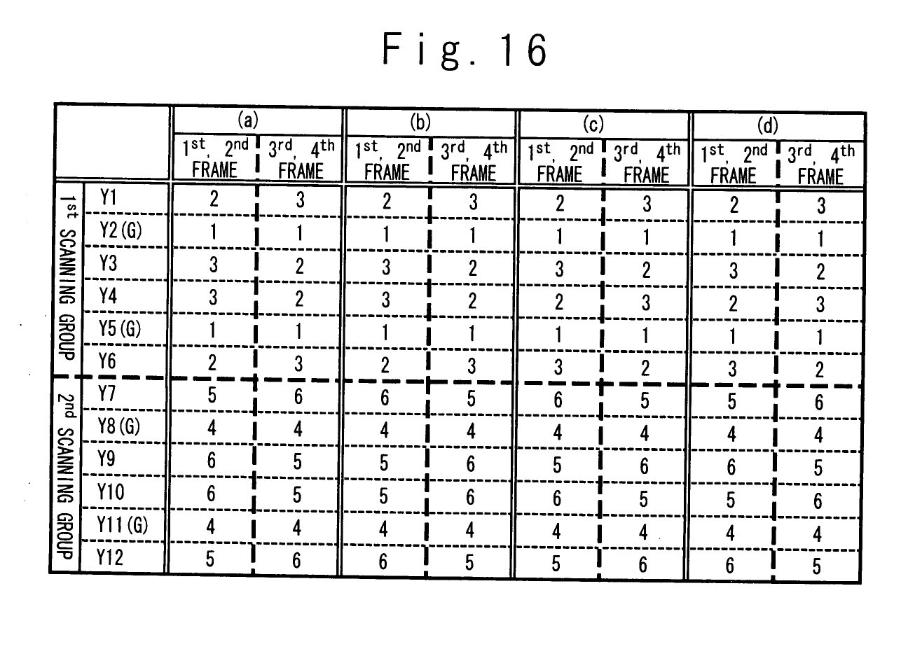

FIG. 15 does not show he voltage polarities every frame period shown in FIG. 13 but the voltage polarity of each liquid crystal cell 9 is different for every one frame period, like that of FIG. 13. A voltage polarity of the data signal is inverted for every two horizontal period and every one frame period. FIG. 16 shows scan orders other than the scan order of FIG. 15. It should be noted that the scan order of FIG. 15 is as shown in a column (a) of FIG. 16.

The scan order of the column (b) of FIG. 16 is different from the scan order of the column (a) of FIG. 16 in the scan order of the second scanning group. Paying attention only to the colors of the liquid crystal cells, the scan order of the first and second scanning groups is GG→RB→BR→GG→BR→RB in the (4j−3)^{th} and (4j−2)^{th} frame periods. The scan order is GG→BR→RB→GG→RB→BR in the (4j−1)^{th} and 4j^{th} frame periods.

In the scan orders of the columns (c) and (d) of FIG. 16, scan lines for the same color are selected at a same time. Paying attention only to the colors of the liquid crystal cells, the scan orders of the first and second scanning groups, the scan order of the column (c) of FIG. 16 is GG→RR→BB→GG→BB→RR in the (4j−3)^{th} and (4j−2)^{th} frame periods. The scan order is GG→BB→RR→GG→RR→BB in the (4j−1)^{th} and 4j^{th} frame periods.

In the scan order of the column (d) of FIG. 16, the scan order and the first scanning group and the scan order of the second scanning group are same. In other words, the scan order of the one frame period in each scanning group is same. Paying attention only to the colors of the liquid crystal cells, the scan order of the first and second scanning groups is GG→RR→BB→GG→RR→BB in the (4j−3)^{th} and (4j−2)^{th} frame periods. The scan order is GG→BB→RR→GG→BB→RR in the (4j−1)^{th} and 4j^{th} frame periods.

The switching of the scan orders of the columns (a), (b), (c), (d) of FIG. 16 has been described mainly every two frame periods. However, like the scan order shown in FIG. 12, the scan order may be switched for every one frame period. In other words, the scan orders of the above-mentioned (4j−3)^{th} frame period and 4j^{th} frame period may be performed for every one frame period.

According to the 3G inverting drive in this embodiment, even if the scan order is any of the columns (a), (b), (c), (d) of FIG. 16, the maximum consumed current amount due to the data signal is approximately ½ of the reference current amount, and it is possible to make the maximum consumed current amount approximately same as the maximum consumed current amount in the column inverting drive. From the viewpoint of dispersing the influence of the preceding data signal, the scan order of FIG. 15, i.e. the scan order of the column (a) of FIG. 16 is the most desirable of the four scan orders, because the scan order is different between the odd-numbered scan groups and even-numbered scan groups. In the scan order of the column (b) of FIG. 16, two pixels receive influence of the preceding data signal to a same color continuously because the scan order of the second scan group and that of the third scan group are same.

The data driver IC 3 inverts the polarity of the data signal for every two horizontal period and one frame period. Also, in the odd-numbered (or even-numbered) two horizontal periods, a positive polarity data signal is outputted onto the data line X1 and the data line X4 and a negative polarity data signal is outputted onto the data line X2 and the data line X3. In the even-numbered (or odd-numbered) two horizontal period, the data signals are inverted, and a negative polarity data signal is outputted onto the data line X1 and the data line X4 and a positive polarity data signal is outputted onto the data line X2 and the data line X3. Since there is a parasitic capacitance between the data line X2, the data line X3, an amount of current consumed between the data lines due to parasitic capacitance can be reduced in the data signals with a same polarity rather than the data signal with opposite polarities.

Also, the data driver IC 3 includes the latch circuits 11 and 12 by which image data for two horizontal periods (for 6 scan lines) can be latched. The data driver IC 3 can latch the image data for four horizontal periods in consideration of the sampling latch. The change of the image data is performed by controlling a multiplexer 20 or a data buffer which supplies the image data to the sampling latch. Which of the scan orders should be performed is determined based on a data in a setting register of the data driver IC 3 or the scan line driving circuit 5 or a signal supplied to an input terminal.

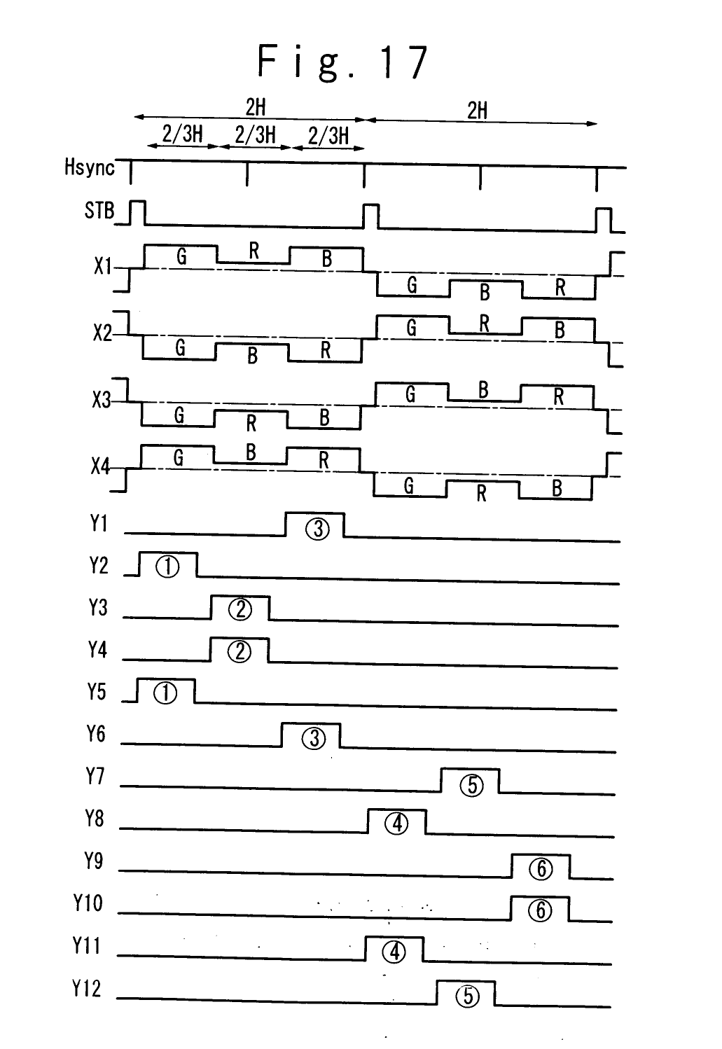

FIG. 17 shows timing charts of the data signal and the scan signal in the first and second horizontal periods of the (4j−3)^{th} frame period, in the scan order shown in FIG. 15. In the blanking period of two first horizontal periods, each data line is precharged to the reference voltage. After that, the G scan lines Y2 and Y5 are selected at a same time, the green positive polarity data signal is supplied to the data lines X1 and X4 and the green (G) negative polarity data signal is supplied to the data lines X2 and X3. Next, the B scan line Y3 and the R scan line Y4 are selected at a same time, the red (R) positive polarity data signal is supplied to the data line X1, and a blue (B) negative polarity data signal is supplied to the data line X2, a red (R) negative polarity data signal is supplied to the data line X3 and a blue (B) positive polarity data signal is supplied to the data line X4. Next, an R scan line Y1 and a B scan line Y6 are selected at a same time, a blue (B) positive polarity data signal is supplied to the data line X1, a red (R) negative polarity data signal is supplied to the data line X2, a blue (B) negative polarity data signal is supplied to the data line X3 and a red (R) positive polarity data signal is supplied to the data line X4.

In the blanking period of the following second two horizontal periods, each data line is precharged to the reference voltage. After that, a G scan lines Y8 and Y11 are selected at a same time, a green (G) negative polarity data signal is supplied to the data lines X1 and X4, and the green (G) positive polarity data signal is supplied to the data lines X2 and X3. Next, the R scan line Y7 and the B scan line Y12 are selected at a same time, and a blue (B) negative polarity data signal is supplied to the data line X1, a red (R) positive polarity data signal is supplied to the data line X2, a blue (B) positive polarity data signal is supplied to the data line X3 and a red (R) negative polarity data signal is supplied to the data line X4. Next, a B scan line Y9, and an R scan line Y10 are selected at a same time, and a red (R) negative polarity data signal is supplied to the data line X1, a blue (B) positive polarity data signal is supplied to the data line X2, a red (R) positive polarity data signal is supplied to the data line X3, and a blue (B) negative polarity data signal is supplied to the data line X4. The description of the operation after this is omitted, but the polarity of the data signal is inverted for every one horizontal period and one frame period, to realize the 3G inverting drive. According to the scan order shown in FIG. 15, because the color influenced with the preceding data signal in the odd-numbered scan groups and the even-numbered scan groups is different, the influence of the preceding data signal can be dispersed.

### Seventh Embodiment

In the first to sixth embodiments of the present invention, three continuously located scan lines are set as one scan group. In the seventh embodiment, three scan lines, each of which is one of every two lines, are set as one scan group. Specifically, a virtual scan line Y(−1), and scan lines Y1 and Y3 are of a scan group a. Scan lines Y2, Y4 and Y6 are of a scan group b. Scan lines Y5, Y7, and Y9 are of a scan group c. Scan lines Y8, Y10, and Y12 are of a scan group d. Scan lines Y11, Y13, and Y15 are of a scan group e. The virtual scan line Y(−1) may be a scan line which does not exist and may exist as dummy scan lines Y0 and Y(−1) through light shielding.

Like the first to sixth embodiments of the present invention, the data lines X1 to Xm is precharged to a predetermined reference voltage in the start of one horizontal period, and after that, the G liquid crystal cell is driven which is connected with the G scan line. Also, the scan order of the scan group is in order of scan groups a, b, c, d, e, . . . .

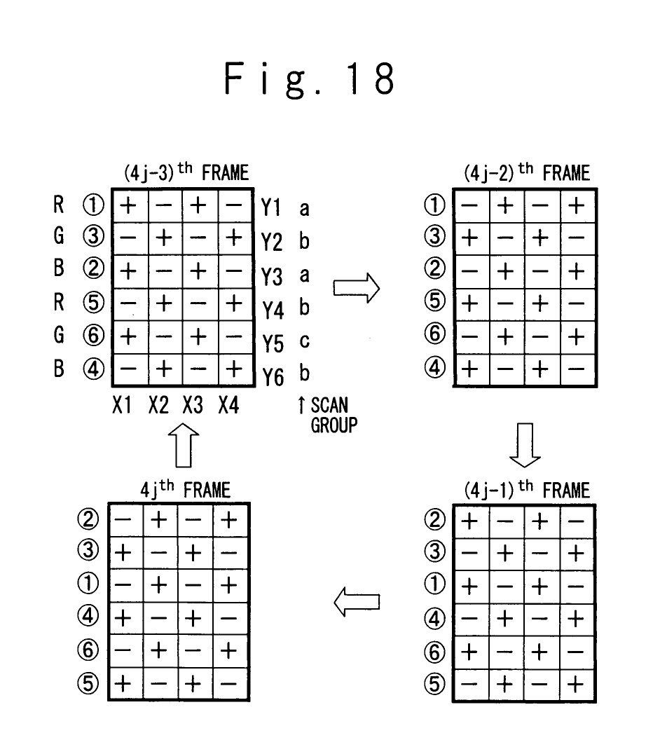

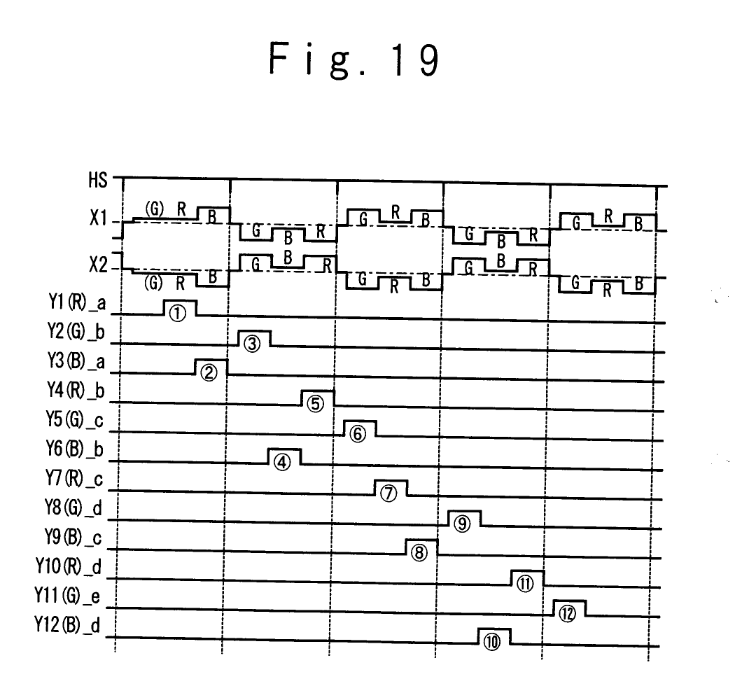

FIGS. 18 and 19 will be described. In the first horizontal period of the (4j−3) th frame period, the data signal is supplied to the liquid crystal cell 9 of the scan group a. Each the data line is precharged to the reference voltage in the start of the first horizontal period. A virtual scan line Y(−1) is selected immediately after the precharged and a virtual data signal of the positive polarity is supplied to the odd-numbered data line X(2k−1) and a negative polarity virtual data signal is supplied to an even-numbered the data line X2k. Next, an R scan line Y1 is selected, and according to the image data of red (R), the positive polarity data signal is supplied to the odd-numbered data line X(2k−1) and a negative polarity data signal is supplied to an even-numbered data line X2k. Next, a B scan line Y3 is selected, and according to the image data of blue (B), the positive polarity data signal is supplied to the odd-numbered data line X(2k−1) and a negative polarity data signal is supplied to even-numbered data line X2k.

Next, in the second horizontal period, the data signal is supplied to the liquid crystal cell of scan group b. A precharge to the reference voltage is performed in the start of second horizontal period. A G scan line Y2 is selected immediately after the precharged, and according to the image data of green (G), a negative polarity data signal is supplied to the odd-numbered data line X(2k−1) and the positive polarity data signal is supplied to an even-numbered the data line X2k. Next, a B scan line Y6 is selected, and according to the image data of blue (B), a negative polarity data signal is supplied to the odd-numbered data line X(2k−1) and the positive polarity data signal is supplied to an even-numbered data line X2k. Next, an R scan line Y4 is selected, and according to the image data of red (R), a negative polarity data signal is supplied to the odd-numbered data line X(2k−1) and the positive polarity data signal is supplied to an even-numbered data line X2k.

Next, in the third horizontal period, the data signal is supplied to the liquid crystal cell of scan group c. A precharge to the reference voltage is performed in the start of third horizontal period. A G scan line Y5 is selected immediately after the precharge, and according to the image data of green (G), the positive polarity data signal is supplied to the odd-numbered data line X(2k−1) and a negative polarity data signal is supplied to an even-numbered data line X2k. Next, an R scan line Y7 is selected, and according to the image data of red (R), the positive polarity data signal is supplied to the odd-numbered data line X(2k−1) and a negative polarity data signal is supplied to an even-numbered data line X2k. Next, a B scan line Y9 is selected, and according to the image data of blue (B), the positive polarity data signal is supplied to the odd-numbered data line X(2k−1) and a negative polarity data signal is supplied to an even-numbered data line X2k. Hereinafter, the driving operation is performed in the fourth horizontal period and the subsequent, like the second and third horizontal periods.

In the (4j−2)^{th} frame period, the liquid crystal cells are driven in the same scan order as the (4j−3)^{th} frame period but a voltage polarity of the data signal supplied to the liquid crystal cell is inverted.

In the (4j−1)^{th} frame period, the scan order of the scan lines is switched which corresponds to a red (R) and a blue (B) to the (4j−3)^{th} frame period. Also, the voltage polarity of the data signal which is supplied to the liquid crystal cell is inverted. Specifically, precharge to the reference voltage is performed in the start of first horizontal period. A virtual scan line Y(−1) is selected immediately after the precharge, and the positive polarity virtual data signal is supplied to the odd-numbered data line X(2k−1) and a negative electrode virtual data signal is supplied to an even-numbered data line X2k. Next, a B scan line Y3 is selected, and according to the image data of blue (B), the positive polarity data signal is supplied to the odd-numbered data line X(2k−1) and a negative polarity data signal is supplied to an even-numbered the data line X2k. Next, an R scan line Y1 is selected and according to the positive polarity data signal, the odd-numbered data line X(2k−1) to the image data of a red (R) and a negative polarity data signal is supplied to even-numbered data line X2k.

Next, in the second horizontal period, the data signal is supplied to the liquid crystal cell of scan group b. A precharge to the reference voltage is performed in the start of the second horizontal period. A G scan line Y2 is selected immediately after the precharge, and according to the image data of green (G), a negative polarity data signal is supplied to the odd-numbered data line X(2k−1) and the positive polarity data signal of the is supplied to an even-numbered data line X2k. Next, an R scan line Y4 is selected, and according to the image data of red (R), a negative polarity data signal is supplied to the odd-numbered data line X(2k−1) and the positive polarity data signal is supplied to an even-numbered data line X2k. Next, an B scan line Y6 is selected, and according to the image data of blue (B), a negative polarity data signal is supplied to the odd-numbered data line X(2k−1) and the data signal of the positive polarity is supplied to an even-numbered data line X2k.

Next, in the third horizontal period, the data signal is supplied to the liquid crystal cell of scan group c. The precharge to the reference voltage is performed in the start of third horizontal period. A G scan line Y5 is selected immediately after the precharge, and according to the image data of green (G), the positive polarity data signal is supplied to the odd-numbered data line X(2k−1) and a negative polarity data signal is supplied to an even-numbered data line X2k. Next, the B scan line Y9 is selected, and according to the image data of blue (B), the positive polarity data signal is supplied to the odd-numbered data line X(2k−1) and a negative polarity data signal is supplied to an even-numbered data line X2k. Next, an R scan line Y7 is selected, and according to the image data of red (R), the positive polarity data signal is supplied to the odd-numbered data line X(2k−1) and a negative polarity data signal is supplied to an even-numbered data line X2k. Hereinafter, the liquid crystal cells are driven in the fourth horizontal period and the subsequent in the same manner as the second and third horizontal periods.

In the 4j^{th} frame period, the liquid crystal cells are driven in the same scan order as (4j−1)^{th} frame period, but the voltage polarity of the data signal supplied to the liquid crystal cell is inverted.

In this embodiment, to drive the virtual scan line (−1) in the first scan group a, the drive period in the one frame period becomes long by one horizontal period, compared with the first embodiment and so on.

By performing the 3G inverting drive in the above-mentioned scan order, pseudo dot inverting display can be attained.

It should be noted that techniques of the first to seventh embodiments can be combined in any arbitrary combination. For example, a combination of the techniques of the first, second, and third embodiments, a combination of the techniques of the first, second, and fourth embodiments, a combination of the techniques of the first to fourth embodiments, a combination of the techniques of the third to fifth embodiments, are possible. A combination of the techniques of the third and sixth embodiments and a combination of the techniques of the fifth and sixth embodiments may be used.

Although the embodiments have been described assuming that the liquid crystal was normally black, it may be normally white. Furthermore, the present invention is applicable also to a display apparatus that uses a display panel, other than the liquid crystal display apparatus. For example, the present invention can be also applied to an organic EL display apparatus, in which the liquid crystal cell 9 is replaced by an organic EL cell. In this case, an organic EL material is filled between the pixel electrode of the organic EL cell and the common electrode facing it. When the present invention is carried out as an organic EL display apparatus, organic EL cells of red (R), green (G), and blue (B) may be realized by organic EL cells emitting white light being coated with the color filters. Alternatively, it is also possible to use organic EL cells emitting lights of respective colors of red (R), green (G), and blue (B), not using the color filters.

Furthermore, it is also possible that as a color system of the display panel, a color system other than the RGB color system is used. In this case, a display cell (the liquid crystal cell 9 or an organic EL cell) corresponding to a color of a highest spectral luminous efficacy is driven immediately after the precharging, and subsequently other display cells are driven.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A method of driving a display panel which comprises a first scan group including first to third scan lines, and a plurality of data lines which intersect said first to third scan lines, wherein a plurality of first display cells of a first color which are connected with said first scan line, a plurality of second display cells of a second color which are connected with said second scan line, a plurality of third display cells of a third color which are connected with said third scan line, said method comprising:
precharging said data lines to a predetermined voltage in a first horizontal period; and
supplying a data signal to said first to third display cells through said data lines driving of said first to third display cells after said data lines are precharged in said first horizontal period,
wherein in said driving of said first to third display cells, one of said first to third display cells which corresponds to one of said first to third colors, having a maximum spectral luminous efficacy, is first driven.

2. The method of driving a display panel according to claim 1, wherein said display panel further comprises a second scan group including fourth to sixth scan lines, wherein said second scan group is provided in adjacent to said first scan group, a plurality of fourth display cells of said first color which are connected with said fourth scan line, a plurality of fifth display cells of said second color which are connected with said fifth scan line, and a plurality of sixth display cells of said third color which are connected with said sixth scan line,
wherein said method comprises:
precharging said data lines to said predetermined voltage in a second horizontal period subsequent to said first horizontal period; and
supplying a data signal to said fourth to sixth display cells through said data lines driving of said fourth to sixth display cells, after said data lines are precharged in said second horizontal period,
wherein in said driving of said fourth to sixth display cells, one of said fourth to sixth display cells corresponding to one of said first to third colors, having said maximum spectral luminous efficacy, is first driven, and
a polarity of said data signal supplied to said first to third display cells which are connected with a first the data line of said data lines is opposite to a polarity of said data signal supplied to said fourth to sixth display cells which are connected with said first data line.

3. The method of driving a display panel according to claim 1, further comprising:
setting a first drive order and a second drive order; and
switching said first drive order and said second drive order for every predetermined period,
wherein in said first drive order, said first to third display cells are driven in an order of one of said first to third display cells corresponding to a color having said maximum spectral luminous efficacy, another of said first to third display cells corresponding to one of said colors other than said color having said maximum spectral luminous efficacy, and said remaining one of said first to third display cells, and
in said second drive order, said first to third display cells are driven in an order of one of said first to third display cells corresponding to said color having said maximum spectral luminous efficacy, said remaining display cell and said another display cell.

4. The method of driving a display panel according to claim 3, wherein said predetermined period is one or two horizontal periods, or one or two frame periods.

5. The method of driving a display panel according to claim 1, wherein said second scan line is provided between said first scan line and said third scan line,
said first to third display cells are connected with one of said data lines, and
said second display cell is located on an opposite side to said first and third display cells with respect to said data line.

6. The method of driving a display panel according to claim 1, wherein said first color, said second color, and said third color are selected from a green color, a red color and a blue color to be different from each other.

7. A display apparatus comprising:
a data driver;
a display panel; and
a scan line driver circuit,
wherein said display panel comprises:
a first scan group including first to third scan lines;
a plurality of data lines which intersect said first to third scan lines,
a plurality of first display cells of a first color which are connected with said first scan line;
a plurality of second display cells of a second color which are connected with said second scan line; and
a plurality of third display cells of a third color which are connected with said third scan line,
said data driver precharges said data lines to a predetermined voltage in a first horizontal period, and supplies a data signal to said first to third display cells through said data lines to drive said first to third display cells, after said data lines are precharged in said first horizontal period,
wherein said scan line driver circuit first drives one of said first to third scan lines which corresponds to one having a maximum spectral luminous efficacy, of said first to third colors.

8. The display apparatus according to claim 7, wherein said display panel further comprises:
a second scan group including fourth to sixth scan lines, wherein said second scan group is provided in adjacent to said first scan group,
a plurality of fourth display cells of said first color which are connected with said fourth scan line;
a plurality of fifth display cells of said second color which are connected with said fifth scan line; and
a plurality of sixth display cells of said third color which are connected with said sixth scan line,
wherein said data driver precharges said data lines to said predetermined voltage in a second horizontal period subsequent to said first horizontal period, and supplies a data signal to said fourth to sixth display cells through said data lines driving of said fourth to sixth display cells, after said data lines are precharged in said second horizontal period,
wherein in said driving of said fourth to sixth display cells, one of said fourth to sixth display cells corresponding to one of said first to third colors, having said maximum spectral luminous efficacy, is first driven, and
a polarity of said data signal supplied to said first to third display cells which are connected with a first data line of said data lines is opposite to a polarity of said data signal supplied to said fourth to sixth display cells which are connected with said first data line.

9. The display apparatus according to claim 7, wherein said data driver drives said display cells such that a first drive order and a second drive order are switched for every predetermined period,
wherein in said first drive order, said first to third display cells are driven in an order of one of said first to third display cells corresponding to a color having said maximum spectral luminous efficacy, another of said first to third display cells corresponding to one of said colors other than said color having said maximum spectral luminous efficacy, and said remaining one of said first to third display cells, and
in said second drive order, said first to third display cells are driven in an order of one of said first to third display cells corresponding to said color having said maximum spectral luminous efficacy, said remaining display cell and said another display cell.

10. The display apparatus according to claim 7, wherein said predetermined period is one or two horizontal periods, or one or two frame periods.

11. The display apparatus according to claim 7, wherein said second scan line is provided between said first scan line and said third scan line,
said first to third display cells are connected with one of said data lines, and
said second display cell is located on an opposite side to said first and third display cells with respect to said data line.

12. The display apparatus according to claim 7, wherein said first color, said second color, and said third color are selected from a green color, a red color and a blue color to be different from each other.

13. A display apparatus comprising:
first to sixth scan lines arranged in this order;
a plurality of first display cells of a first color connected to said first scan line;
a plurality of second display cells of a second color connected to said second scan line;
a plurality of third display cells of a third color connected to said third scan line;
a plurality of fourth display cells of said first color connected to said fourth scan line;
a plurality of fifth display cells of said second color connected to said fifth scan line;
a plurality of sixth display cells of said third color connected to said sixth scan line; and
data lines arranged to intersect said first to sixth scan lines,
wherein in said first to sixth display cells connected with one of said data lines, said second and fifth display cells are arranged on an opposite side to said first, third, fourth, and sixth display cells with respect to said one data line.
